(19) United States
(12) Patent Application Publication
(10) Pub. No.: US 2025/0214716 A1
(43) Pub. Date: Jul. 3, 2025

(54) Payload Holding Faceplate for Payload Retrieval System

(71) Applicant: Wing Aviation LLC, Palo Alto, CA (US)

(72) Inventors: Elizabeth Chase Marshman, San Francisco, CA (US); Jasper Lee Lewin, Santa Cruz, CA (US); Ivan Qiu, Redwood City, CA (US); Winnie Elva Ding, Redwood City, CA (US)

(21) Appl. No.: 18/400,963

(22) Filed: Dec. 29, 2023

(51) Int. Cl. B64U 10/60; B64U 101/64; B64U 101/67

(52) U.S. Cl. CPC B64F 1/32; B64D 1/22; B64U 2101/64; B64U 2101/67

(57) ABSTRACT

A payload retrieval system includes a support structure and a retriever guide coupled to the support structure. The retriever guide forms a channel having an inlet end and an exit end. The retriever guide is adapted to receive a payload retriever at the inlet end of the channel and direct the payload retriever to the exit end of the channel. The payload retrieval system also includes a faceplate coupled to the retriever guide. The faceplate includes a body extending around a passage aligned with the exit end of the channel, and a payload holder including first and second hooks adapted to hold a payload for receipt by a payload retriever that passes through the retriever guide.

### BACKGROUND

An uncrewed vehicle, which may also be referred to as an autonomous vehicle, is a vehicle capable of travel without a physically-present human operator. The term “unmanned” may sometimes be used instead of, or in addition to, “uncrewed,” and it should be understood that both terms have the same meaning, and may be used interchangeably. An uncrewed vehicle may operate in a remote-control mode, in an autonomous mode, or in a partially autonomous mode.

When an uncrewed vehicle operates in a remote-control mode, a pilot or driver that is at a remote location can control the uncrewed vehicle via commands that are sent to the uncrewed vehicle via a wireless link. When the uncrewed vehicle operates in autonomous mode, the uncrewed vehicle typically moves based on pre-programmed navigation waypoints, dynamic automation systems, or a combination of these. Further, some uncrewed vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of uncrewed vehicles exist for various different environments. For instance, uncrewed vehicles exist for operation in the air, on the ground, underwater, and in space. Examples include quad-copters and tail-sitter UAVs, among others. Uncrewed vehicles also exist for hybrid operations in which multi-environment operation is possible. Examples of hybrid uncrewed vehicles include an amphibious craft that is capable of operation on land as well as on water or a floatplane that is capable of landing on water as well as on land. Other examples are also possible.

### SUMMARY

The present embodiments are directed to a payload retrieval system. The system includes a payload holder and a retriever guide to direct a payload retriever to the payload holder for retrieving a payload from the payload holder.

In one aspect a payload retrieval system is provided. The payload retrieval system includes a support structure and a retriever guide coupled to the support structure. The retriever guide forms a channel having an inlet end and an exit end. The retriever guide is adapted to receive a payload retriever at the inlet end of the channel and direct the payload retriever to the exit end of the channel. The payload retrieval system also includes a faceplate coupled to the retriever guide. The faceplate includes a body extending around a passage aligned with the exit end of the channel, and a payload holder including first and second hooks adapted to hold a payload for receipt by a payload retriever that passes through the retriever guide.

In another aspect another payload retrieval system is provided. The payload retrieval system includes a support structure and a retriever guide formed of a first material and coupled to the support structure. The retriever guide includes a channel having an inlet end and an exit end. The retriever guide is adapted to receive a payload retriever at the inlet end of the channel and direct the payload retriever to the exit end of the channel. The payload retrieval system also includes a faceplate formed of a second material that is different from the first material. The faceplate is coupled to the retriever guide and includes a body extending around a passage aligned with the exit end of the channel. The faceplate also includes a payload holder adapted to hold a payload for receipt by a payload retriever that passes through the retriever guide.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1A is a simplified illustration of an uncrewed aerial vehicle, according to an example embodiment.

FIG. 1B is a simplified illustration of an uncrewed aerial vehicle, according to an example embodiment.

FIG. 1C is a simplified illustration of an uncrewed aerial vehicle, according to an example embodiment.

FIG. 1D is a simplified illustration of an uncrewed aerial vehicle, according to an example embodiment.

FIG. 1E is a simplified illustration of an uncrewed aerial vehicle, according to an example embodiment.

FIG. 2 is a simplified block diagram illustrating components of an uncrewed aerial vehicle, according to an example embodiment.

FIG. 3 is a simplified block diagram illustrating a UAV system, according to an example embodiment.

FIGS. 4A, 4B, and 4C show a payload delivery apparatus, according to an example embodiment.

FIG. 5 shows a perspective view of a payload delivery apparatus according to an example embodiment.

FIG. 6 shows a perspective view of a payload coupling apparatus according to an example embodiment.

FIG. 7 shows a side view of a handle of a payload according to an example embodiment.

FIG. 8 shows a pair of locking pins engaging a handle of a payload according to an example embodiment.

FIG. 9 is a perspective view of payload retrieval apparatus according to an example embodiment.

FIG. 10 shows a sequence of steps A-D performed in the retrieval of a payload from the payload retrieval apparatus of FIG. 9.

FIG. 11A is a side cross-sectional view of a retriever guide of the payload retrieval apparatus of FIG. 9.

FIG. 11B is a perspective view of the inlet side of the retriever guide of FIG. 11A.

FIG. 11C is a perspective view of the exit side of the retriever guide of FIG. 11A.

FIG. 12 is a detailed cross-sectional view of a payload retriever passing through the exit of the retriever guide of FIG. 11A according to an example embodiment.

FIG. 13A is a perspective view of a portion of the payload retrieval apparatus of FIG. 9.

FIG. 13B is a perspective view of the portion of FIG. 13A with various components hidden from view.

FIG. 13C is a perspective view of the portion of FIG. 13A with the retriever guide removed from the support structure.

FIG. 14 shows a row of two payload retrieval apparatuses according to an example embodiment.

FIG. 15 is an exploded view of the retriever guide of FIG. 11A.

FIG. 16 is a perspective view of a funnel of the retriever guide of FIG. 11A.

FIG. 17A is a perspective view of a rotator of the retriever guide of FIG. 11A.

FIG. 17B is a cross-sectional view of the rotator of FIG. 17A showing a portion of the rotator that includes the tether slot.

FIG. 17C is a cross-sectional view of the rotator of FIG. 17A showing an opposing portion of the rotator that is opposite the tether slot.

FIG. 18 is a side view of an angle adjuster of the retriever guide of FIG. 11A.

FIG. 19 is a perspective view of the angle adjuster of FIG. 18.

FIG. 20A is a side view of the angle adjuster of FIG. 18 showing a cutaway line A-A.

FIG. 20B is a lower perspective view of a cross-section of the angle adjuster of FIG. 18 in accordance with the cutaway line of FIG. 20A.

FIG. 21A is a front perspective view of a faceplate including a payload holder of the payload retrieval apparatus of FIG. 9.

FIG. 21B is a rear perspective view of the faceplate of FIG. 21A.

FIG. 22 is an exploded view of a faceplate, payload bay, and angle adjuster of the payload retrieval apparatus of FIG. 9.

FIG. 23A is a side view of the faceplate and angle adjuster of FIG. 22 showing a cutaway line B-B.

FIG. 23B is a perspective view of a cross-section of the faceplate and angle adjuster of FIG. 22 in accordance with the cutaway line of FIG. 23A.

FIG. 24A front view of the faceplate of FIG. 21A showing a cutaway line C-C.

FIG. 24B is a detailed cross-sectional side view of a hook of the faceplate of FIG. 21A.

FIG. 25 is a front view of the faceplate of FIG. 21A with a payload loaded thereon.

### DETAILED DESCRIPTION

Exemplary methods and systems are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

### I. Overview

The present embodiments are related to a payload retrieval apparatus configured to provide a payload to a UAV that includes a payload retriever attached to a tether. The payload retrieval apparatus includes a payload holder and a retriever guide including a channel that is configured to direct the payload retriever to the payload holder. To retrieve the payload, the UAV lowers the tether so that the payload retriever is near an inlet end of the retriever guide. The UAV then operates to pull the payload retriever through the channel of the retriever guide. The payload holder is positioned near an exit end of the channel such that the payload retriever can remove a payload from the payload holder as it leaves the channel.

In the disclosed embodiments, the payload holder is formed as part of a faceplate that is attached to the retriever guide at an exit end of the channel. The faceplate includes a body that attaches to the retriever guide and the payload holder extending outward from a surface of the faceplate. In some embodiments, the payload holder is configured as a pair of hooks on either side of a passage that is aligned with the channel exit. Further, in some embodiments the faceplate is formed of a different material than the retriever guide. This may allow the faceplate to assist the retriever guide in holding its shape.

Further details and other embodiments of the payload retrieval system according to the disclosure are described in more detail below.

### II. Illustrative Uncrewed Vehicles

Herein, the terms “uncrewed aerial vehicle” and “UAV” refer to any autonomous or semi-autonomous vehicle that is capable of performing some functions without a physically present human pilot.

A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), or “uncrewed aerial system” (UAS) may also be used to refer to a UAV.

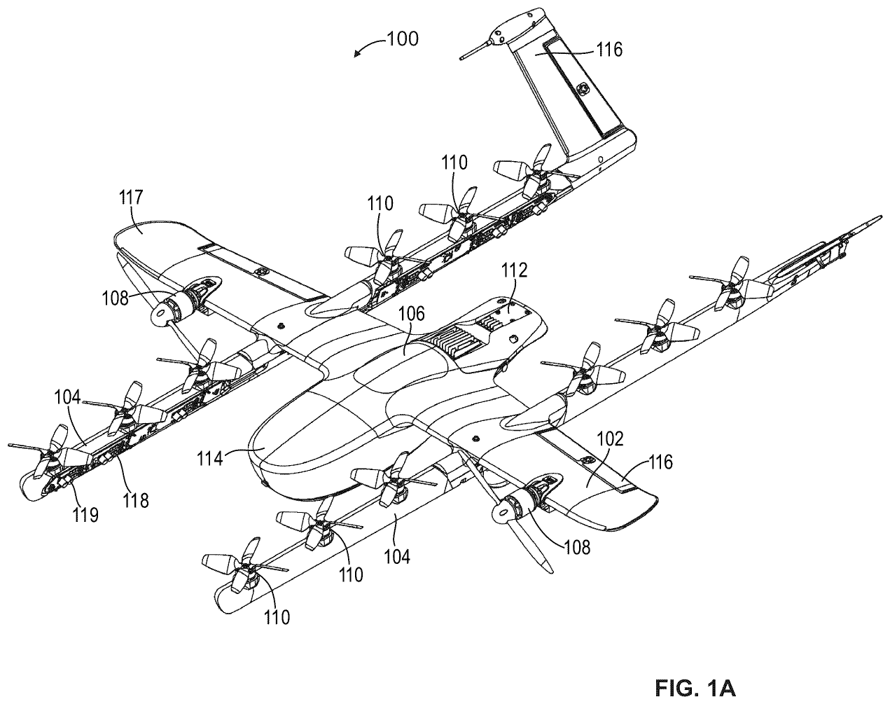

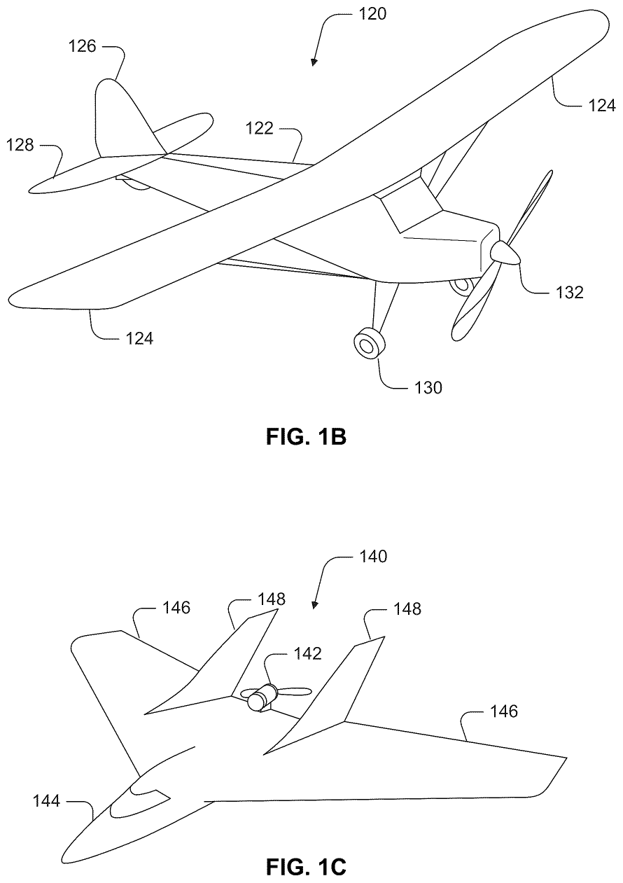

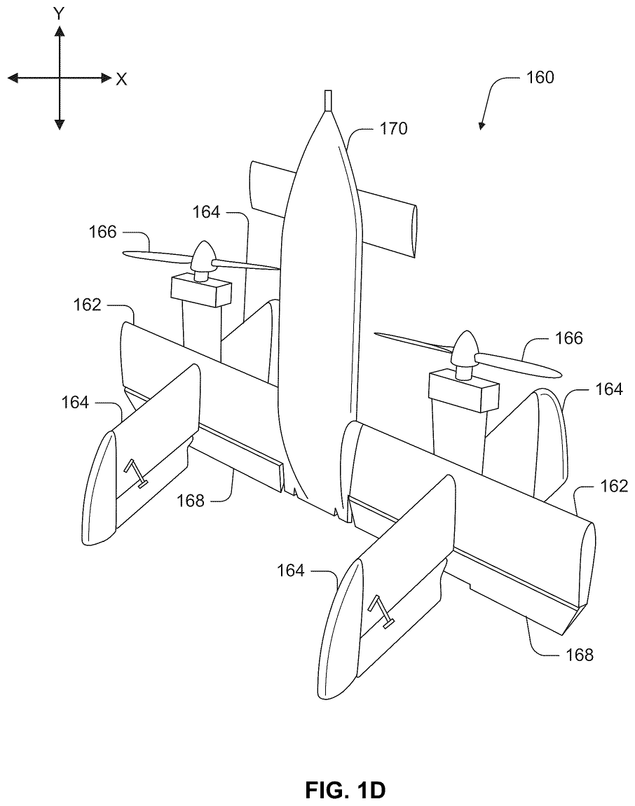

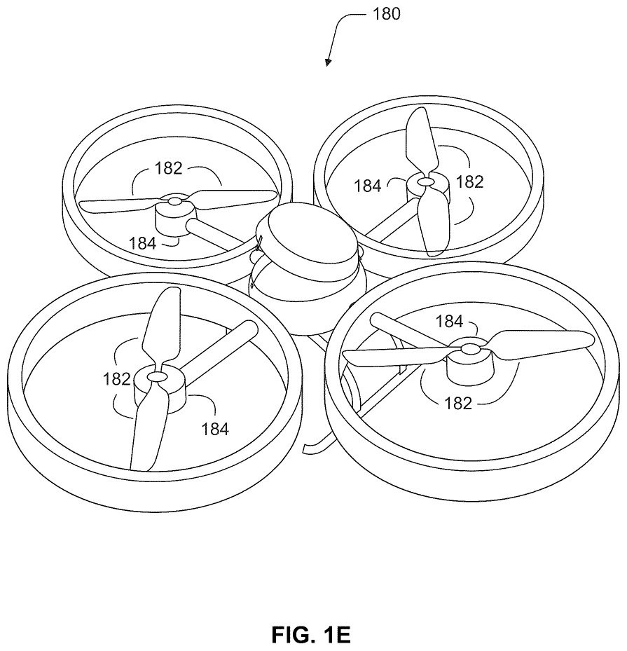

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1A illustrates two wings 102, two booms 104, two horizontal propulsion units 108, and six vertical propulsion units 110 per boom 104, it should be appreciated that other variants of UAV 100 may be implemented with more or fewer of these components. For example, UAV 100 may include four wings 102, four booms 104, and more or fewer propulsion units (horizontal or vertical).

Similarly, FIG. 1B shows another example of a fixed-wing UAV 120. The fixed-wing UAV 120 includes a fuselage 122, two wings 124 with an airfoil-shaped cross section to provide lift for the UAV 120, a vertical stabilizer 126 (or fin) to stabilize the plane's yaw (turn left or right), a horizontal stabilizer 128 (also referred to as an elevator or tailplane) to stabilize pitch (tilt up or down), landing gear 130, and a propulsion unit 132, which can include a motor, shaft, and propeller.

FIG. 1C shows an example of a UAV 140 with a propeller in a pusher configuration. The term “pusher” refers to the fact that a propulsion unit 142 is mounted at the back of the UAV and “pushes” the vehicle forward, in contrast to the propulsion unit being mounted at the front of the UAV. Similar to the description provided for FIGS. 1A and 1, FIG. 1C depicts common structures used in a pusher plane, including a fuselage 144, two wings 146, vertical stabilizers 148, and the propulsion unit 142, which can include a motor, shaft, and propeller.

FIG. 1D shows an example of a tail-sitter UAV 160. In the illustrated example, the tail-sitter UAV 160 has fixed wings 162 to provide lift and allow the UAV 160 to glide horizontally (e.g., along the x-axis, in a position that is approximately perpendicular to the position shown in FIG. 1D). However, the fixed wings 162 also allow the tail-sitter UAV 160 to take off and land vertically on its own.

For example, at a launch site, the tail-sitter UAV 160 may be positioned vertically (as shown) with its fins 164 and/or wings 162 resting on the ground and stabilizing the UAV 160 in the vertical position. The tail-sitter UAV 160 may then take off by operating its propellers 166 to generate an upward thrust (e.g., a thrust that is generally along the y-axis). Once at a suitable altitude, the tail-sitter UAV 160 may use its flaps 168 to reorient itself in a horizontal position, such that its fuselage 170 is closer to being aligned with the x-axis than the y-axis. Positioned horizontally, the propellers 166 may provide forward thrust so that the tail-sitter UAV 160 can fly in a similar manner as a typical airplane.

As noted above, some embodiments may involve other types of UAVs, in addition to or in the alternative to fixed-wing UAVs. For instance, FIG. 1E shows an example of a rotorcraft that is commonly referred to as a multicopter 180. The multicopter 180 may also be referred to as a quadcopter, as it includes four rotors 182. It should be understood that example embodiments may involve a rotorcraft with more or fewer rotors than the multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to the multicopter 180 in greater detail, the four rotors 182 provide propulsion and maneuverability for the multicopter 180. More specifically, each rotor 182 includes blades that are attached to a motor 184. Configured as such, the rotors 182 may allow the multicopter 180 to take off and land vertically, to maneuver in any direction, and/or to hover. Further, the pitch of the blades may be adjusted as a group and/or differentially, and may allow the multicopter 180 to control its pitch, roll, yaw, and/or altitude.

It should be understood that references herein to an “uncrewed” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Illustrative UAV Components

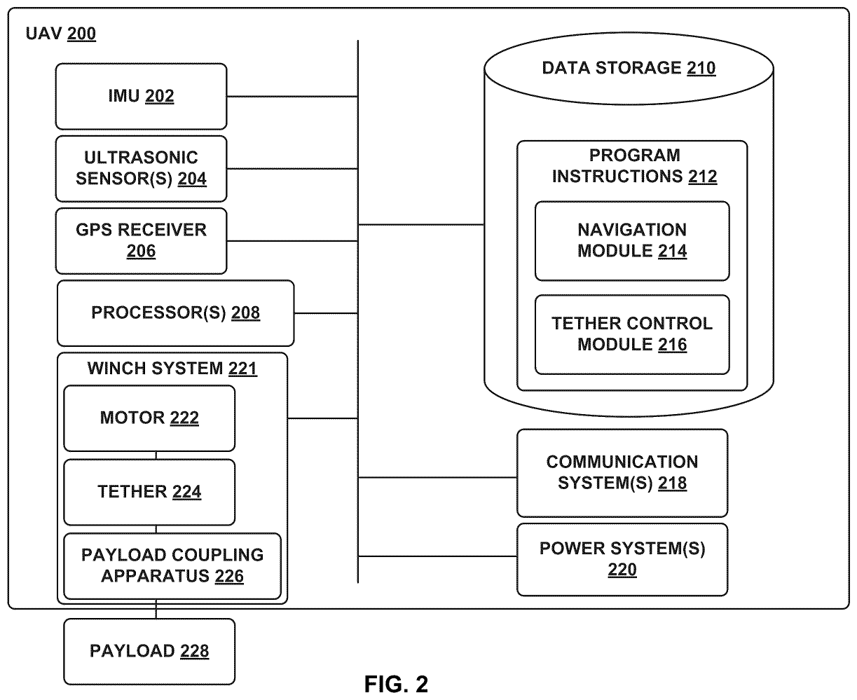

FIG. 2 is a simplified block diagram illustrating components of a UAV 200, according to an example embodiment. UAV 200 may take the form of, or be similar in form to, one of the UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include an inertial measurement unit (IMU) 202, ultrasonic sensor(s) 204, and a GPS 206, among other possible sensors and sensing systems.

In the illustrated embodiment, UAV 200 also includes one or more processors 208. A processor 208 may be a general-purpose processor or a special purpose processor (e.g., digital signal processors, application specific integrated circuits, etc.). The one or more processors 208 can be configured to execute computer-readable program instructions 212 that are stored in the data storage 210 and are executable to provide the functionality of a UAV described herein.

The data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of the one or more processors 208. In some embodiments, the data storage 210 can be implemented using a single physical device (e.g., one optical, magnetic, organic or other memory or disc storage unit), while in other embodiments, the data storage 210 can be implemented using two or more physical devices.

As noted, the data storage 210 can include computer-readable program instructions 212 and perhaps additional data, such as diagnostic data of the UAV 200. As such, the data storage 210 may include program instructions 212 to perform or facilitate some or all of the UAV functionality described herein. For instance, in the illustrated embodiment, program instructions 212 include a navigation module 214 and a tether control module 216.

### A. Sensors

In an illustrative embodiment, IMU 202 may include both an accelerometer and a gyroscope, which may be used together to determine an orientation of the UAV 200. In particular, the accelerometer can measure the orientation of the vehicle with respect to earth, while the gyroscope measures the rate of rotation around an axis. IMUs are commercially available in low-cost, low-power packages. For instance, an IMU 202 may take the form of or include a miniaturized MicroElectroMechanical System (MEMS) or a NanoElectroMechanical System (NEMS). Other types of IMUs may also be utilized.

An IMU 202 may include other sensors, in addition to accelerometers and gyroscopes, which may help to better determine position and/or help to increase autonomy of the UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of the UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include a GPS receiver 206. The GPS receiver 206 may be configured to provide data that is typical of well-known GPS systems, such as the GPS coordinates of the UAV 200. Such GPS data may be utilized by the UAV 200 for various functions. As such, the UAV may use its GPS receiver 206 to help navigate to the caller's location, as indicated, at least in part, by the GPS coordinates provided by their mobile device. Other examples are also possible.

### B. Navigation and Location Determination

The navigation module 214 may provide functionality that allows the UAV 200 to, e.g., move about its environment and reach a desired location. To do so, the navigation module 214 may control the altitude and/or direction of flight by controlling the mechanical features of the UAV that affect flight (e.g., its rudder(s), elevator(s), aileron(s), and/or the speed of its propeller(s)).

In order to navigate the UAV 200 to a target location, the navigation module 214 may implement various navigation techniques, such as map-based navigation and localization-based navigation, for instance. With map-based navigation, the UAV 200 may be provided with a map of its environment, which may then be used to navigate to a particular location on the map. With localization-based navigation, the UAV 200 may be capable of navigating in an unknown environment using localization. Localization-based navigation may involve the UAV 200 building its own map of its environment and calculating its position within the map and/or the position of objects in the environment. For example, as a UAV 200 moves throughout its environment, the UAV 200 may continuously use localization to update its map of the environment. This continuous mapping process may be referred to as simultaneous localization and mapping (SLAM). Other navigation techniques may also be utilized.

In some embodiments, the navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, the navigation module 214 and/or other components and systems of the UAV 200 may be configured for “localization” to more precisely navigate to the scene of a target location. More specifically, it may be desirable in certain situations for a UAV to be within a threshold distance of the target location where a payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, the UAV 200 may navigate to the general area of a target destination where a payload 228 is being delivered using waypoints and/or map-based navigation. The UAV may then switch to a mode in which it utilizes a localization process to locate and travel to a more specific location. For instance, if the UAV 200 is to deliver a payload to a user's home, the UAV 200 may need to be substantially close to the target location in order to avoid delivery of the payload to undesired areas (e.g., onto a roof, into a pool, onto a neighbor's property, etc.). However, a GPS signal may only get the UAV 200 so far (e.g., within a block of the user's home). A more precise location-determination technique may then be used to find the specific target location.

Various types of location-determination techniques may be used to accomplish localization of the target delivery location once the UAV 200 has navigated to the general area of the target delivery location. For instance, the UAV 200 may be equipped with one or more sensory systems, such as, for example, ultrasonic sensors 204, infrared sensors (not shown), and/or other sensors, which may provide input that the navigation module 214 utilizes to navigate autonomously or semi-autonomously to the specific target location.

As another example, once the UAV 200 reaches the general area of the target delivery location (or of a moving subject such as a person or their mobile device), the UAV 200 may switch to a “fly-by-wire” mode where it is controlled, at least in part, by a remote operator, who can navigate the UAV 200 to the specific target location. To this end, sensory data from the UAV 200 may be sent to the remote operator to assist them in navigating the UAV 200 to the specific location.

As yet another example, the UAV 200 may include a module that is able to signal to a passer-by for assistance in either reaching the specific target delivery location; for example, the UAV 200 may display a visual message requesting such assistance in a graphic display, play an audio message or tone through speakers to indicate the need for such assistance, among other possibilities. Such a visual or audio message might indicate that assistance is needed in delivering the UAV 200 to a particular person or a particular location, and might provide information to assist the passer-by in delivering the UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once the UAV 200 arrives at the general area of a target delivery location, the UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, the UAV 200 may be configured to navigate by “sourcing” such directional signals—in other words, by determining where the signal is strongest and navigating accordingly. As another example, a mobile device can emit a frequency, either in the human range or outside the human range, and the UAV 200 can listen for that frequency and navigate accordingly. As a related example, if the UAV 200 is listening for spoken commands, then the UAV 200 could utilize spoken statements, such as “I'm over here!” to source the specific location of the person requesting delivery of a payload.

In an alternative arrangement, a navigation module may be implemented at a remote computing device, which communicates wirelessly with the UAV 200. The remote computing device may receive data indicating the operational state of the UAV 200, sensor data from the UAV 200 that allows it to assess the environmental conditions being experienced by the UAV 200, and/or location information for the UAV 200. Provided with such information, the remote computing device may determine latitudinal and/or directional adjustments that should be made by the UAV 200 and/or may determine how the UAV 200 should adjust its mechanical features (e.g., its rudder(s), elevator(s), aileron(s), and/or the speed of its propeller(s)) in order to effectuate such movements. The remote computing system may then communicate such adjustments to the UAV 200 so it can move in the determined manner.

### C. Communication Systems

In a further aspect, the UAV 200 includes one or more communication systems 218. The communications systems 218 may include one or more wireless interfaces and/or one or more wireline interfaces, which allow the UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, a UAV 200 may include communication systems 218 that allow for both short-range communication and long-range communication. For example, the UAV 200 may be configured for short-range communications using Bluetooth and for long-range communications under a CDMA protocol. In such an embodiment, the UAV 200 may be configured to function as a “hot spot;” or in other words, as a gateway or proxy between a remote support device and one or more data networks, such as a cellular network and/or the Internet. Configured as such, the UAV 200 may facilitate data communications that the remote support device would otherwise be unable to perform by itself.

For example, the UAV 200 may provide a WiFi connection to a remote device, and serve as a proxy or gateway to a cellular service provider's data network, which the UAV might connect to under an LTE or a 3G protocol, for instance. The UAV 200 could also serve as a proxy or gateway to a high-altitude balloon network, a satellite network, or a combination of these networks, among others, which a remote device might not be able to otherwise access.

### D. Power Systems

In a further aspect, the UAV 200 may include power system(s) 220. The power system 220 may include one or more batteries for providing power to the UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

### E. Payload Delivery

The UAV 200 may employ various systems and configurations in order to transport and deliver a payload 228. In some implementations, the payload 228 of a given UAV 200 may include or take the form of a “package” designed to transport various goods to a target delivery location. For example, the UAV 200 can include a compartment, in which an item or items may be transported. Such a package may include one or more food items, purchased goods, medical items, or any other object(s) having a size and weight suitable to be transported between two locations by the UAV. In other embodiments, a payload 228 may simply be the one or more items that are being delivered (e.g., without any package housing the items).

In some embodiments, the payload 228 may be attached to the UAV and located substantially outside of the UAV during some or all of a flight by the UAV. For example, the package may be tethered or otherwise releasably attached below the UAV during flight to a target location. In some embodiments, the package may include various features that protect its contents from the environment, reduce aerodynamic drag on the system, and prevent the contents of the package from shifting during UAV flight. In other embodiments, the package may be a standard shipping package that is not specifically tailored for UAV flight.

In order to deliver the payload, the UAV may include a winch system 221 controlled by the tether control module 216 in order to lower the payload 228 to the ground while the UAV hovers above. As shown in FIG. 2, the winch system 221 may include a tether 224, and the tether 224 may be coupled to the payload 228 by a payload retriever 226. The tether 224 may be wound on a spool that is coupled to a motor 222 of the UAV. The motor 222 may take the form of a DC motor (e.g., a servo motor) that can be actively controlled by a speed controller. The tether control module 216 can control the speed controller to cause the motor 222 to rotate the spool, thereby unwinding or retracting the tether 224 and lowering or raising the payload retriever 226. In practice, the speed controller may output a desired operating rate (e.g., a desired RPM) for the spool, which may correspond to the speed at which the tether 224 and payload 228 should be lowered towards the ground. The motor 222 may then rotate the spool so that it maintains the desired operating rate.

In order to control the motor 222 via the speed controller, the tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as the motor 222 causes rotation of the spool, a rotary encoder may be used to measure this rotation. In doing so, the rotary encoder may be used to convert a rotary position to an analog or digital electronic signal used by the tether control module 216 to determine the amount of rotation of the spool from a fixed reference angle and/or to an analog or digital electronic signal that is representative of a new rotary position, among other options. Other examples are also possible.

Based on the data from the speed sensor, the tether control module 216 may determine a rotational speed of the motor 222 and/or the spool and responsively control the motor 222 (e.g., by increasing or decreasing an electrical current supplied to the motor 222) to cause the rotational speed of the motor 222 to match a desired speed. When adjusting the motor current, the magnitude of the current adjustment may be based on a proportional-integral-derivative (PID) calculation using the determined and desired speeds of the motor 222. For instance, the magnitude of the current adjustment may be based on a present difference, a past difference (based on accumulated error over time), and a future difference (based on current rates of change) between the determined and desired speeds of the spool.

In some embodiments, the tether control module 216 may vary the rate at which the tether 224 and payload 228 are lowered to the ground. For example, the speed controller may change the desired operating rate according to a variable deployment-rate profile and/or in response to other factors in order to change the rate at which the payload 228 descends toward the ground. To do so, the tether control module 216 may adjust an amount of braking or an amount of friction that is applied to the tether 224. For example, to vary the tether deployment rate, the UAV 200 may include friction pads that can apply a variable amount of pressure to the tether 224. As another example, the UAV 200 can include a motorized braking system that varies the rate at which the spool lets out the tether 224. Such a braking system may take the form of an electromechanical system in which the motor 222 operates to slow the rate at which the spool lets out the tether 224. Further, the motor 222 may vary the amount by which it adjusts the speed (e.g., the RPM) of the spool, and thus may vary the deployment rate of the tether 224. Other examples are also possible.

In some embodiments, the tether control module 216 may be configured to limit the motor current supplied to the motor 222 to a maximum value. With such a limit placed on the motor current, there may be situations where the motor 222 cannot operate at the desired rate specified by the speed controller. For instance, as discussed in more detail below, there may be situations where the speed controller specifies a desired operating rate at which the motor 222 should retract the tether 224 toward the UAV 200, but the motor current may be limited such that a large enough downward force on the tether 224 would counteract the retracting force of the motor 222 and cause the tether 224 to unwind instead. And as further discussed below, a limit on the motor current may be imposed and/or altered depending on an operational state of the UAV 200.

In some embodiments, the tether control module 216 may be configured to determine a status of the tether 224 and/or the payload 228 based on the amount of current supplied to the motor 222. For instance, if a downward force is applied to the tether 224 (e.g., if the payload 228 is attached to the tether 224 or if the tether 224 gets snagged on an object when retracting toward the UAV 200), the tether control module 216 may need to increase the motor current in order to cause the determined rotational speed of the motor 222 and/or spool to match the desired speed. Similarly, when the downward force is removed from the tether 224 (e.g., upon delivery of the payload 228 or removal of a tether snag), the tether control module 216 may need to decrease the motor current in order to cause the determined rotational speed of the motor 222 and/or spool to match the desired speed. As such, the tether control module 216 may be configured to monitor the current supplied to the motor 222. For instance, the tether control module 216 could determine the motor current based on sensor data received from a current sensor of the motor or a current sensor of the power system 220. In any case, based on the current supplied to the motor 222, determine if the payload 228 is attached to the tether 224, if someone or something is pulling on the tether 224, and/or if the payload retriever 226 is pressing against the UAV 200 after retracting the tether 224. Other examples are possible as well.

During delivery of the payload 228, the payload retriever 226 can be configured to secure the payload 228 while being lowered from the UAV by the tether 224, and can be further configured to release the payload 228 upon reaching ground level. The payload retriever 226 can then be retracted to the UAV by reeling in the tether 224 using the motor 222.

In some implementations, the payload 228 may be passively released once it is lowered to the ground. For example, a passive release mechanism may include one or more swing arms adapted to retract into and extend from a housing. An extended swing arm may form a hook on which the payload 228 may be attached. Upon lowering the release mechanism and the payload 228 to the ground via a tether, a gravitational force as well as a downward inertial force on the release mechanism may cause the payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of the payload 228 no longer forces the swing arm to extend from the housing. Retracting the swing arm into the housing may reduce the likelihood of the release mechanism snagging the payload 228 or other nearby objects when raising the release mechanism toward the UAV upon delivery of the payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, a UAV 200 could include an air-bag drop system or a parachute drop system. Alternatively, a UAV 200 carrying a payload could simply land on the ground at a delivery location. Other examples are also possible.

### IV. Illustrative UAV Deployment Systems

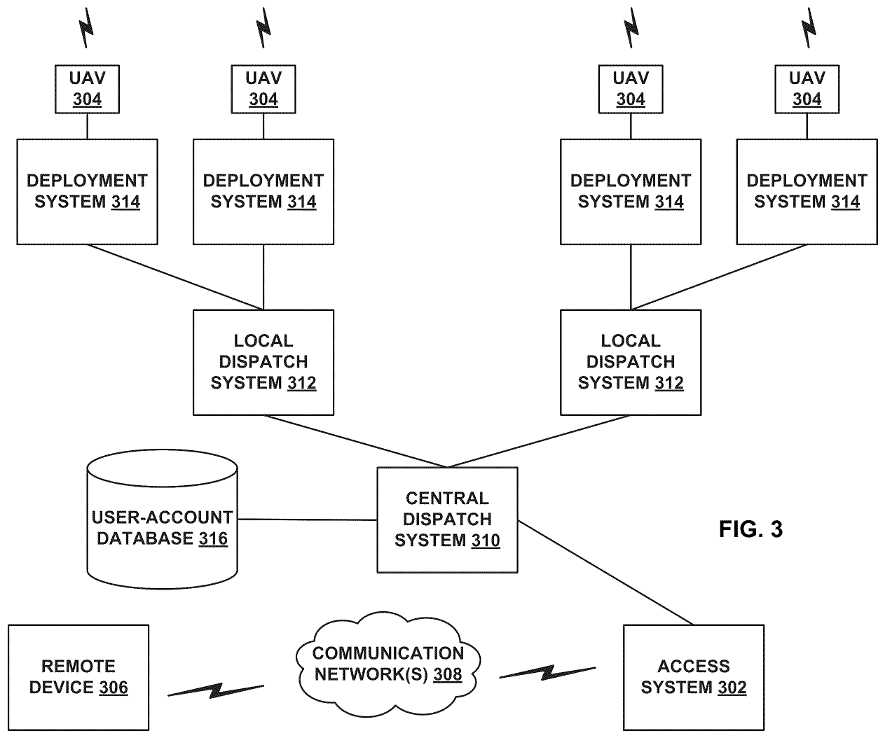

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, an access system 302 may allow for interaction with, control of, and/or utilization of a network of UAVs 304. In some embodiments, an access system 302 may be a computing system that allows for human-controlled dispatch of UAVs 304. As such, the control system may include or otherwise provide a user interface through which a user can access and/or control the UAVs 304.

In some embodiments, dispatch of the UAVs 304 may additionally or alternatively be accomplished via one or more automated processes. For instance, the access system 302 may dispatch one of the UAVs 304 to transport a payload to a target location, and the UAV may autonomously navigate to the target location by utilizing various on-board sensors, such as a GPS receiver and/or other various navigational sensors.

Further, the access system 302 may provide for remote operation of a UAV. For instance, the access system 302 may allow an operator to control the flight of a UAV via its user interface. As a specific example, an operator may use the access system 302 to dispatch a UAV 304 to a target location. The UAV 304 may then autonomously navigate to the general area of the target location. At this point, the operator may use the access system 302 to take control of the UAV 304 and navigate the UAV to the target location (e.g., to a particular person to whom a payload is being transported). Other examples of remote operation of a UAV are also possible.

In an illustrative embodiment, the UAVs 304 may take various forms. For example, each of the UAVs 304 may be a UAV such as those illustrated in FIGS. 1A-1E. However, UAV system 300 may also utilize other types of UAVs without departing from the scope of the invention. In some implementations, all of the UAVs 304 may be of the same or a similar configuration. However, in other implementations, the UAVs 304 may include a number of different types of UAVs. For instance, the UAVs 304 may include a number of types of UAVs, with each type of UAV being configured for a different type or types of payload delivery capabilities.

The UAV system 300 may further include a remote device 306, which may take various forms. Generally, the remote device 306 may be any device through which a direct or indirect request to dispatch a UAV can be made. (Note that an indirect request may involve any communication that may be responded to by dispatching a UAV, such as requesting a package delivery). In an example embodiment, the remote device 306 may be a mobile phone, tablet computer, laptop computer, personal computer, or any network-connected computing device. Further, in some instances, the remote device 306 may not be a computing device. As an example, a standard telephone, which allows for communication via plain old telephone service (POTS), may serve as the remote device 306. Other types of remote devices are also possible.

Further, the remote device 306 may be configured to communicate with access system 302 via one or more types of communication network(s) 308. For example, the remote device 306 may communicate with the access system 302 (or a human operator of the access system 302) by communicating over a POTS network, a cellular network, and/or a data network such as the Internet. Other types of networks may also be utilized.

In some embodiments, the remote device 306 may be configured to allow a user to request delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, the UAV system 300 may receive location information (e.g., GPS coordinates, etc.) from the user's mobile phone, or any other device on the user's person, such that a UAV can navigate to the user's location (as indicated by their mobile phone).

In an illustrative arrangement, the central dispatch system 310 may be a server or group of servers, which is configured to receive dispatch messages requests and/or dispatch instructions from the access system 302. Such dispatch messages may request or instruct the central dispatch system 310 to coordinate the deployment of UAVs to various target locations. The central dispatch system 310 may be further configured to route such requests or instructions to one or more local dispatch systems 312. To provide such functionality, the central dispatch system 310 may communicate with the access system 302 via a data network, such as the Internet or a private network that is established for communications between access systems and automated dispatch systems.

In the illustrated configuration, the central dispatch system 310 may be configured to coordinate the dispatch of UAVs 304 from a number of different local dispatch systems 312. As such, the central dispatch system 310 may keep track of which UAVs 304 are located at which local dispatch systems 312, which UAVs 304 are currently available for deployment, and/or which services or operations each of the UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when the central dispatch system 310 receives a request for UAV-related service (e.g., transport of an item) from the access system 302, the central dispatch system 310 may select a specific UAV 304 to dispatch. The central dispatch system 310 may accordingly instruct the local dispatch system 312 that is associated with the selected UAV to dispatch the selected UAV. The local dispatch system 312 may then operate its associated deployment system 314 to launch the selected UAV. In other cases, the central dispatch system 310 may forward a request for a UAV-related service to a local dispatch system 312 that is near the location where the support is requested and leave the selection of a particular UAV 304 to the local dispatch system 312.

In an example configuration, the local dispatch system 312 may be implemented as a computing system at the same location as the deployment system(s) 314 that it controls. For example, the local dispatch system 312 may be implemented by a computing system installed at a building, such as a warehouse, where the deployment system(s) 314 and UAV(s) 304 that are associated with the particular local dispatch system 312 are also located. In other embodiments, the local dispatch system 312 may be implemented at a location that is remote to its associated deployment system(s) 314 and UAV(s) 304.

Numerous variations on, and alternatives to, the illustrated configuration of the UAV system 300 are possible. For example, in some embodiments, a user of the remote device 306 could request delivery of a package directly from the central dispatch system 310. To do so, an application may be implemented on the remote device 306 that allows the user to provide information regarding a requested delivery, and generate and send a data message to request that the UAV system 300 provide the delivery. In such an embodiment, the central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to the central dispatch system 310, the local dispatch system(s) 312, the access system 302, and/or the deployment system(s) 314 may be combined in a single system, implemented in a more complex system, and/or redistributed among the central dispatch system 310, the local dispatch system(s) 312, the access system 302, and/or the deployment system(s) 314 in various ways.

Yet further, while each local dispatch system 312 is shown as having two associated deployment systems 314, a given local dispatch system 312 may alternatively have more or fewer associated deployment systems 314. Similarly, while the central dispatch system 310 is shown as being in communication with two local dispatch systems 312, the central dispatch system 310 may alternatively be in communication with more or fewer local dispatch systems 312.

In a further aspect, the deployment systems 314 may take various forms. In general, the deployment systems 314 may take the form of or include systems for physically launching one or more of the UAVs 304. Such launch systems may include features that provide for an automated UAV launch and/or features that allow for a human-assisted UAV launch. Further, the deployment systems 314 may each be configured to launch one particular UAV 304, or to launch multiple UAVs 304.

The deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, the deployment systems 314 and their corresponding UAVs 304 (and possibly associated local dispatch systems 312) may be strategically distributed throughout an area such as a city. For example, the deployment systems 314 may be strategically distributed such that each deployment system 314 is proximate to one or more payload pickup locations (e.g., near a restaurant, store, or warehouse). However, the deployment systems 314 (and possibly the local dispatch systems 312) may be distributed in other ways, depending upon the particular implementation. As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, the UAV system 300 may include or have access to a user-account database 316. The user-account database 316 may include data for a number of user accounts, and which are each associated with one or more persons. For a given user account, the user-account database 316 may include data related to or useful in providing UAV-related services. Typically, the user data associated with each user account is optionally provided by an associated user and/or is collected with the associated user's permission.

Further, in some embodiments, a person may be required to register for a user account with the UAV system 300, if they wish to be provided with UAV-related services by the UAVs 304 from UAV system 300. As such, the user-account database 316 may include authorization information for a given user account (e.g., a username and password), and/or other information that may be used to authorize access to a user account.

In some embodiments, a person may associate one or more of their devices with their user account, such that they can access the services of UAV system 300. For example, when a person uses an associated mobile phone, e.g., to place a call to an operator of the access system 302 or send a message requesting a UAV-related service to a dispatch system, the phone may be identified via a unique device identification number, and the call or message may then be attributed to the associated user account. Other examples are also possible.

### V. Illustrative Payload Delivery Systems

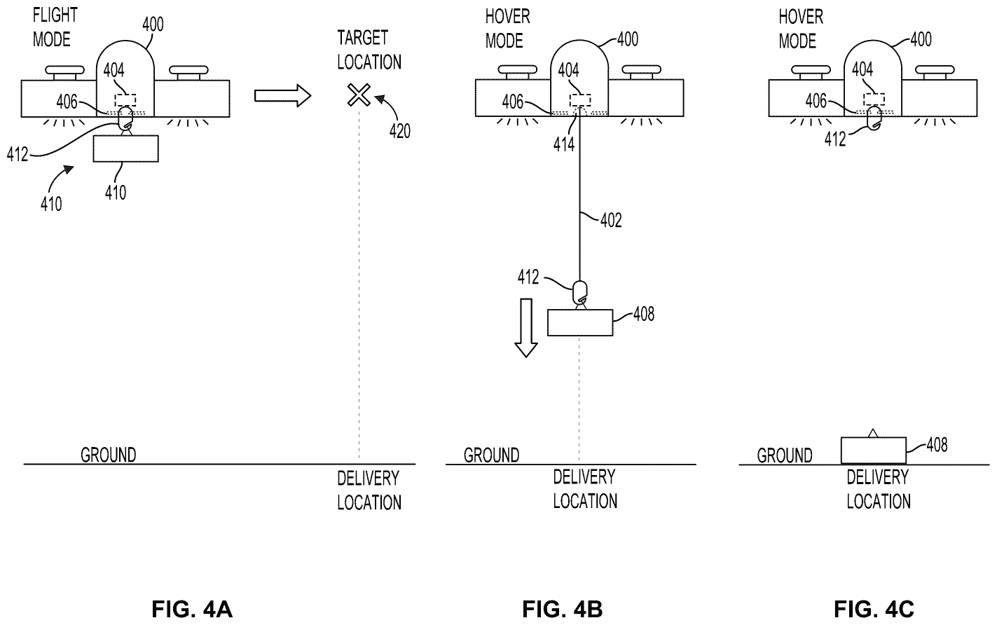

FIGS. 4A, 4B, and 4C show a UAV 400 that includes a payload delivery system 410 according to an example embodiment. As shown, payload delivery system 410 for UAV 400 includes a tether 402 coupled to a spool 404, a payload latch 406, and a payload 408 coupled to the tether 402 via a payload coupling apparatus (or payload retriever) 412. The payload latch 406 can function to alternately secure payload 408 and release the payload 408 for delivery. For instance, as shown, the payload latch 406 may take the form of one or more pins that can engage a portion of the payload 408. Inserting the pins of the payload latch 406 into the payload coupling apparatus 412 may secure the payload coupling apparatus 412 within a receptacle 414 on the underside of the UAV 400, thereby preventing the payload 408 from being lowered from the UAV 400. In some embodiments, the payload latch 406 may be arranged to engage the spool 404 or the payload 408 rather than the payload coupling apparatus 412 in order to prevent the payload 408 from lowering. In other embodiments, the UAV 400 may not include the payload latch 406, and the payload delivery apparatus may be coupled directly to the UAV 400.

In some embodiments, the spool 404 can function to unwind the tether 402 such that the payload 408 can be lowered to the ground with the tether 402 and the payload coupling apparatus 412 from UAV 400. The payload 408 may itself be an item for delivery, and may be housed within (or otherwise incorporate) a parcel, container, or other structure that is configured to interface with the payload latch 406. In practice, the payload delivery system 410 of UAV 400 may function to autonomously lower payload 408 to the ground in a controlled manner to facilitate delivery of the payload 408 on the ground while the UAV 400 hovers above.

As shown in FIG. 4A, the payload latch 406 may be in a closed position (e.g., pins engaging the payload coupling apparatus 412) to hold the payload 408 against or close to the bottom of the UAV 400, or even partially or completely inside the UAV 400, during flight from a launch site to a target location 420. The target location 420 may be a point in space directly above a desired delivery location. Then, when the UAV 400 reaches the target location 420, the UAV's control system (e.g., the tether control module 216 of FIG. 2) may toggle the payload latch 406 to an open position (e.g., disengaging the pins from the payload coupling apparatus 412), thereby allowing the payload 408 to be lowered from the UAV 400. The control system may further operate the spool 404 (e.g., by controlling the motor 222 of FIG. 2) such that the payload 408, secured to the tether 402 by a payload coupling apparatus 412, is lowered to the ground, as shown in FIG. 4B.

Once the payload 408 reaches the ground, the control system may continue operating the spool 404 to lower the tether 402, causing over-run of the tether 402. During over-run of the tether 402, the payload coupling apparatus 412 may continue to lower as the payload 408 remains stationary on the ground. The downward momentum and/or gravitational forces on the payload coupling apparatus 412 may cause the payload 408 to detach from the payload coupling apparatus 412 (e.g., by sliding off a hook of the payload coupling apparatus 412). After releasing payload 408, the control system may operate the spool 404 to retract the tether 402 and the payload coupling apparatus 412 toward the UAV 400. Once the payload coupling apparatus reaches or nears the UAV 400, the control system may operate the spool 404 to pull the payload coupling apparatus 412 into the receptacle 414, and the control system may toggle the payload latch 406 to the closed position, as shown in FIG. 4C.

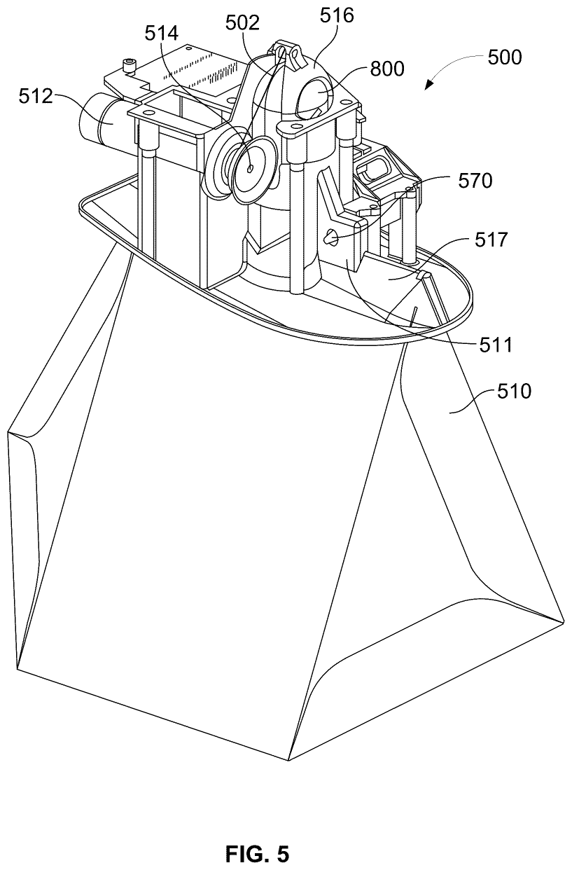

FIG. 5 shows a perspective view of a payload delivery apparatus 500 including payload 510, according to an example embodiment. The payload delivery apparatus 500 is positioned within a fuselage of a UAV and includes a winch 514 powered by motor 512, and a tether 502 spooled onto winch 514. The tether 502 is attached to a payload coupling apparatus or payload retriever positioned within a payload retriever receptacle 516. A payload 510 is secured to a payload retriever (or payload coupling apparatus) 800. In this embodiment a top portion 517 of payload 510 is secured within the fuselage of the UAV. A locking pin 570 is shown extending through handle 511 attached to payload 510 to positively secure the payload beneath the UAV during high-speed flight.

FIG. 5 shows a payload 510 taking the shape of an aerodynamic hexagonally-shaped tote, where the base and side walls are six-sided hexagons and the tote includes generally pointed front and rear surfaces formed at the intersections of the side walls and base of the tote providing an aerodynamic shape. In other embodiments, the payload may have other shapes or forms.

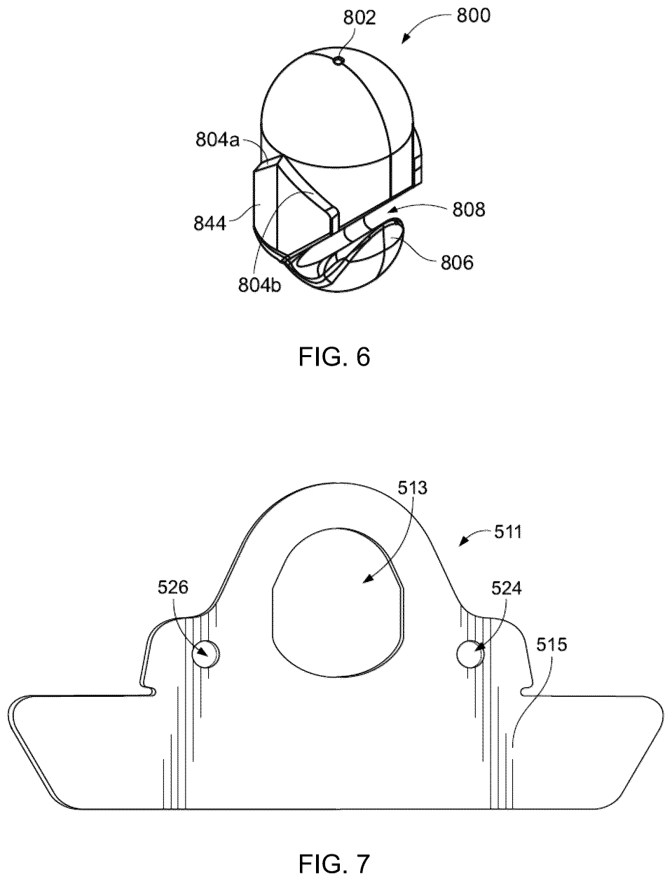

FIG. 6 is a perspective view of payload retriever 800 according to an example embodiment. Payload retriever 800 includes a tether mounting point 802 at the top of the payload retriever and a slot 808 adapted to receive a handle of a payload. Lower lip, or hook, 806 is formed beneath slot 808. Payload retriever 800 also includes outer protrusions 804 having helical cam surfaces 804a and 804b that are adapted to mate with corresponding cam mating surfaces to orient the payload coupling apparatus 800. Corresponding mating surfaces may be included within a receptacle in the fuselage of a UAV, or in a payload retrieval structure, as described in more detail below.

FIG. 7 is a side view of a handle 511 of a payload 510 configured to be carried by a UAV. The handle 511 includes an aperture 513 through which the hook of a payload retriever extends to suspend the payload during delivery or retrieval. The handle 511 includes a lower portion 515 that is secured to the top portion of a payload. Also included are holes 524 and 526 through which locking pins positioned within the fuselage of a UAV, may extend to secure the handle and payload in a secure position during high speed forward flight to a delivery location. In addition, holes 524 and 526 are also designed to receive pins of a payload holder for holding the payload in position on a payload retrieval apparatus. The handle may be comprised of a thin, flexible plastic material that provides sufficient strength to suspend the payload beneath a UAV during flight to a delivery site, and during delivery and/or retrieval of a payload. In practice, the handle may be bent to position the handle within a slot of a payload retriever.

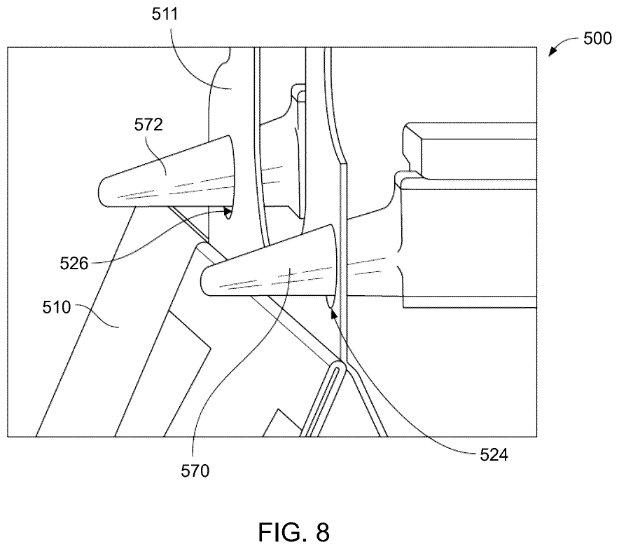

FIG. 8 shows a pair of pins 570, 572 extending through holes 524 and 526 in handle 511 of payload 510 to secure the handle 511 and top portion of payload 510 within the fuselage of a UAV. In this manner, the handle 511 and payload 510 may be secured within the fuselage of a UAV, or to a payload holder of a payload retrieval apparatus. In the illustrated embodiment, the pins 570 and 572 have a conical shape, which may help guide entry into the holes 524, 546. In other embodiments, the pins may have another shape, such as cylindrical. In some embodiments the pins 570 and 572 may completely plug the holes 524 and 526 of the handle 511 of payload 510, to provide a secure attachment of the handle and top portion of the payload within the fuselage of the UAV, or to secure the payload to a payload retrieval apparatus.

### VI. Illustrative Payload Retrieval Systems

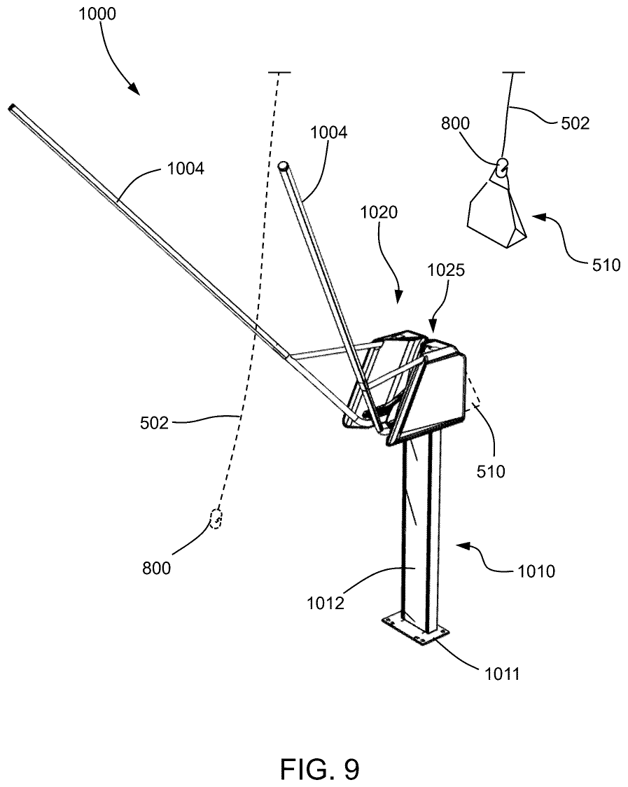

FIG. 9 is a perspective view of payload retrieval apparatus 1000 having a payload 510 positioned thereon, according to an example embodiment. The payload retrieval apparatus 1000 is configured to hold the payload 510 at the exit end of a retriever guide 1020 that directs a payload retriever 800 to the payload 510. The retriever guide 1020 is secured in place by a support structure 1010 that protects the retriever guide 1020 and holds the retriever guide 1020 at an elevated height. The elevated height of the retriever guide 1020 allows the payload retriever 800 to be pulled upward through the retriever guide 1020 by retracting the tether 502 into the UAV, for example by a winch. The payload retrieval apparatus 1000 also includes a pair of tether engagers 1004 that direct the tether 502 toward the inlet end of the retriever guide 1020, so that the payload retriever 800 is pulled into the retriever guide 1020 when the tether 502 is retracted. In FIG. 9, the dashed lines show the tether 502, payload retriever 800, and payload 510 before the payload retriever 800 passes through the payload retrieval apparatus 1000, while the solid lines show tether 502, payload retriever 800, and payload 510 after the payload 510 has been retrieved.

The support structure 1010 of the payload retrieval apparatus 1000 includes a frame for supporting the retriever guide 1020 and may include a pedestal 1012 to hold the retriever guide 1020 at an elevated height. Based on the construction of the pedestal 1012, the payload retrieval apparatus 1000 may be a permanent or non-permanent structure placed at the payload retrieval site. For example, the pedestal may include a base 1011 that is attached to the underlying structure, such as a paved surface, or the pedestal may be positioned within a corresponding hole in the ground. Alternatively, if the payload retrieval apparatus 1000 is mobile, it may include wheels or another mobile structure at the bottom of the pedestal 1012. Portions of the payload retrieval apparatus 1000, such as tether engagers 1004 described below, may be disassembled or folded, to provide for ease of transport or a smaller footprint when not in use.

The retriever guide 1020 includes a channel 1022 that guides the payload retriever 800 toward the payload 510. As previously stated, the payload retriever 800 is drawn through the payload retrieval apparatus 1000 by a tether 502. Accordingly, to accommodate the tether 502, the retriever guide 1020 includes a tether slot 1025 along the top. As the payload retriever 800 is guided through the channel 1022, the tether 502 slides along the tether slot 1025.

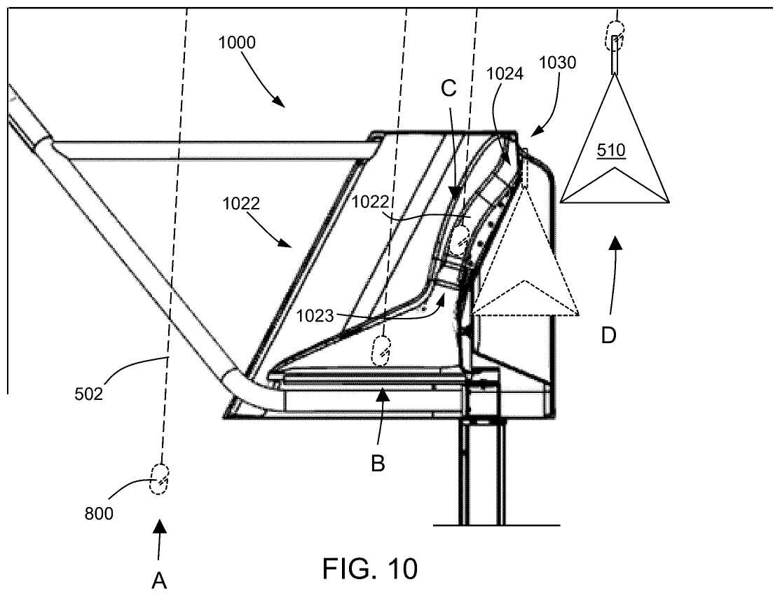

FIG. 10 shows a sequence of steps A-D performed in the retrieval of payload 510 from the payload retrieval apparatus 1000, shown in FIG. 9. As shown, the payload retrieval apparatus 1000 includes a payload holder 1030 that holds the payload 510 at the end of the channel 1022 of the retriever guide 1020. The steps shown in FIG. 10 illustrate the payload retriever 800 as it moves through the channel 1022 of the retriever guide 1020 from an inlet end 1023 of the channel 1022 to an exit end 1024 of the channel 1022. The payload holder 1030 is positioned at the exit end 1024 of the channel 1022, such that the payload retriever 800 receives the payload 510 as the payload retriever 800 leaves the retriever guide 1020. At point A in the sequence of steps shown from left to right, payload retriever 800 is shown suspended at the end of tether 502, with the payload retriever 800 below the retriever guide 1020 and the tether 502 between the tether engagers 1004. As the tether 502 moves to the right, the tether engagers 1004 and the inlet end of the retriever guide 1020 constrain the tether 502 so that the payload retriever 800 ends up under the retriever guide 1020.

As the tether 502 is retracted upward, the payload retriever 800 enters the retriever guide 1020 of the payload retrieval apparatus, as shown at point B. With continued retraction of the tether 502, the payload retriever 800 is drawn through the channel 1022 of the retriever guide 1020, as shown at point C. As the payload retriever 800 exits the channel 1022, it engages a handle 511 of the payload 510 and the payload retriever 800 removes the payload 510 from the payload holder 1030. After removal of payload 510 from the payload holder 1030, at point D of the sequence, payload 510 is suspended from tether 502 with handle 511 of payload 510 secured to the payload retriever 800. The payload 510 and tether 502 may be then winched up to the UAV and flown for subsequent delivery at a payload delivery site.

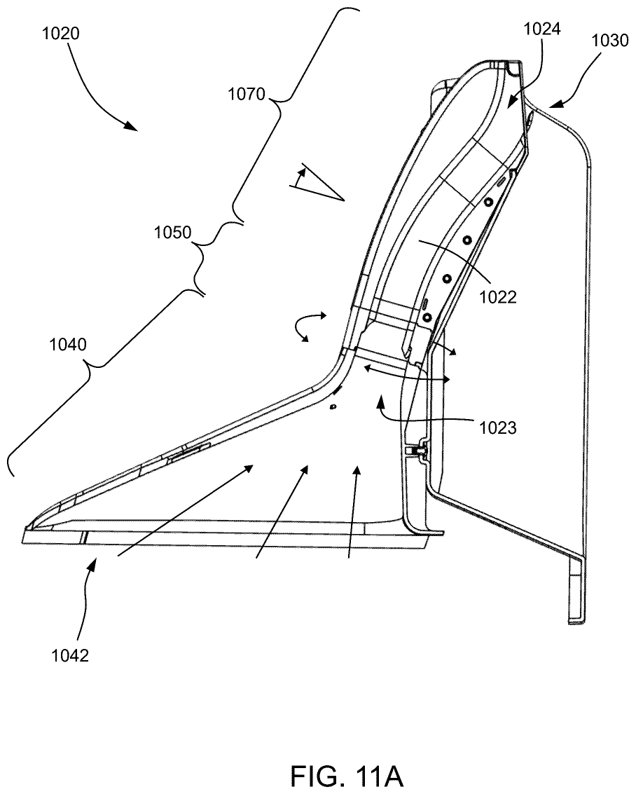

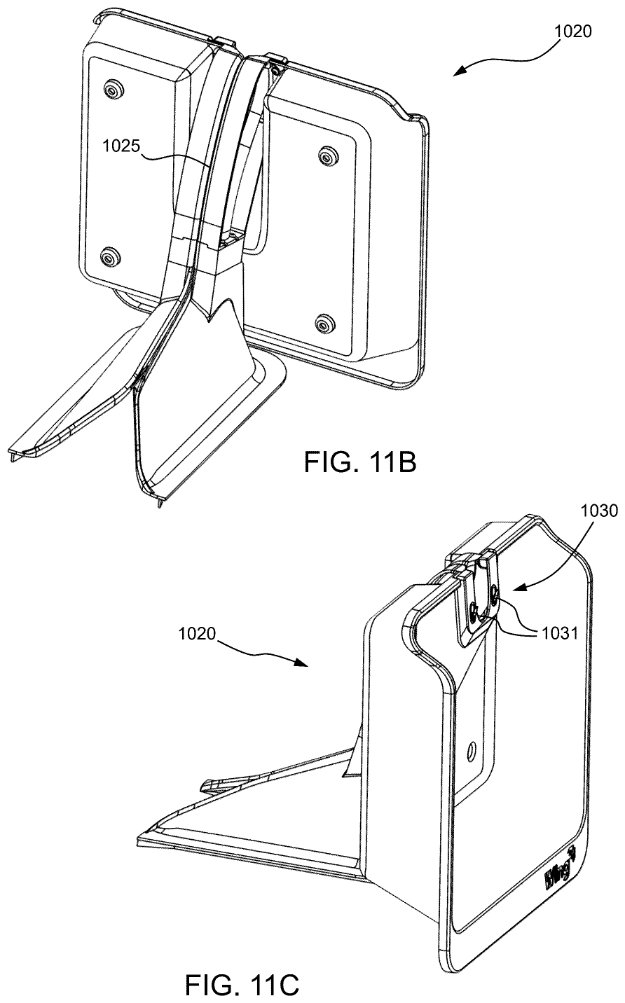

FIGS. 11A-11C illustrate the retriever guide 1020 of FIG. 9 in isolation from the support structure 1010 and other parts of the payload retrieval apparatus 1000. FIG. 11A shows a cross-sectional side view of the retriever guide 1020 that illustrates various functional components of the retriever guide 1020 that interact with a payload retriever in different ways as the payload retriever passes through the retriever guide 1020. As explained in more detail below, the retriever guide includes a funnel 1040, a rotator 1050, an angle adjuster 1070, and a payload holder 1030. FIG. 11B shows a perspective view of the inlet side of the retriever guide 1020 and more clearly shows the tether slot 1025 that extends along the channel of the retriever guide and allows the tether to extend into the channel and pull the payload retriever. FIG. 11C shows a perspective view of the exit side of the retriever guide 1020. A pair of hooks 1031 that form the payload holder 1030 can be seen on either side of the exit end 1024 of the channel. FIGS. 11A-11C also show a payload bay 1090 that is formed as part of the retriever guide 1020. The payload bay 1090 provides a partially enclosed area beneath the payload holder 1030 for protecting the payload from wind or other environmental hazards.

As shown in FIG. 11A, the funnel 1040 forms the inlet end 1023 of the channel 1022 or retriever guide 1020. The funnel 1040 is configured to guide the payload retriever into the channel 1022. The funnel 1040 has a wide mouth 1042 that opens downward and forms the inlet to the funnel 1040. The area surrounded by the mouth 1042 is configured to be substantially larger than the cross-sectional area of the payload retriever, such as at least 500% larger, so that the payload retriever can enter the retriever guide 1020 from various positions under the funnel 1040, as illustrated by the arrows that point into the funnel 1040. From the large open mouth 1042, the funnel 1040 tapers inward to the inlet end 1023 of the channel 1022, which has a smaller opening that is configured to more closely correspond to the size of the payload retriever.

As illustrated in FIG. 11A, the retriever guide 1020 also includes a rotator 1050 that is configured to rotate the payload retriever about the direction of travel of the payload retriever as it moves through the channel 1022. This rotation may also be understood as rotation around an axis that is aligned with the tether when the payload retriever is hanging from the tether. In aviation, this rotation would be described as roll. The rotator 1050 includes components along the channel 1022 to provide the rotation of the retriever. The rotation of the payload retriever within the rotator 1050 is illustrated by the elliptical arrangement of arrows adjacent to the rotator 1050 in FIG. 11A.

In some embodiments, the rotator 1050 includes one or more guiding protrusions that are operable to engage corresponding surfaces of the payload retriever in order to rotate the retriever as it passes through the associated portion of the channel. Such protrusions may be configured as helical surfaces that form cams along an interior of the channel. When a corresponding surface of the payload retriever contacts a cam, it slides along the helical surface of the cam that borders the channel and is caused to rotate about the direction of travel. In other embodiments, the rotator includes other components that cause the payload retriever to rotate as it passes through the rotator. For example, in some embodiments, the rotator includes magnets that interact with corresponding magnets on the payload retriever in order to rotate the payload retriever. A rotator including other components that cause the retriever to rotate are also possible.

In some embodiments, the rotator 1050 is oriented so that the direction of travel through the rotator 1050 is substantially vertical, where the phrase substantially vertical is used herein to mean closer to vertical than to horizontal. For example, in some embodiments, the direction of travel along the channel 1022 through the rotator 1050 is inclined by at least 65°, for example in a range of 70° to 85°, such as around 75°. Because the force that pulls the payload retriever through the channel is imparted by the airborne UAV through the hanging tether, forces in the vertical direction may translate more readily to the payload retriever. In particular, in various embodiments, winching the retriever upward by retracting the tether may be an effective way to impart forces on the retriever in order to move the retriever through the channel. Thus, where the channel is directed more vertically, a larger component of the force on the retriever is utilized to move the payload retriever through the channel and less force is directed to lateral movement or sliding against the walls of the channel. On the other hand, as the retriever is drawn through the rotator, a portion of the force is redirected to impart rotation to the retriever. By having the rotator oriented more vertically, a larger percentage of the force may be available to rotate the payload retriever.

The retriever guide 1020 also includes an angle adjuster 1070, that reduces the angle of inclination of the channel 1022 toward an exit end 1024 of the channel 1022. The change in angle imparted by the angle adjuster 1070 is illustrated by the icon of an angle adjacent to the angle adjuster 1070 in FIG. 11A. This change in the angle of the channel 1022 both tilts the retriever forward and increases the forward movement of the retriever as the retriever nears the exit end 1024 of the channel 1022. As a result, when the retriever nears the exit end 1024 of the channel 1022 it has a significant forward motion, which helps the retriever engage the payload. Then, as the retriever exits the channel it is pulled upward by the tether and can lift the payload off the payload holder 1030.

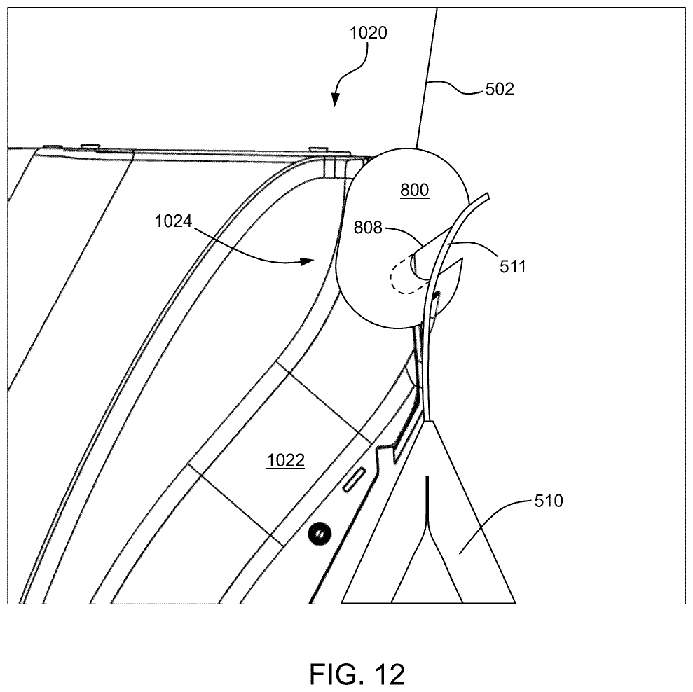

FIG. 12 illustrates a payload retriever 800 leaving the channel 1022 of the retriever guide 1020 and in the process of retrieving the payload 510. As shown, the exit end 1024 of the channel 1022 opens upward so that the payload retriever 800 is being pulled substantially upward as it leaves the channel 1022. The handle 511 of payload 510 is secured on the payload holder 1030 with the top of the handle 511 positioned to sit in the path of the payload retriever 800 as it exits the channel 1022. In this embodiment, the handle 511 is flexible and the payload retriever 800 is shown contacting the handle 511 and bending it back as the payload retriever is pulled through the channel 1022. As the payload retriever 800 continues to be pulled by the tether 502, it will rotate upward and the handle 511 will be caught in the slot 808 of the payload retriever 800. The payload 510 is then lifted off the payload holder 1030 and removed from the payload retrieval apparatus.

In addition to the aforementioned functional components of the retriever guide, the retriever guide may include other components that interact with the payload retriever or provide other functionality. Further, the illustrated procedure of removing the payload from the payload retrieval apparatus is merely one of various ways in which the payload may be retrieved by the UAV.

### VII. Modular Construction of Illustrative Payload Retrieval Systems

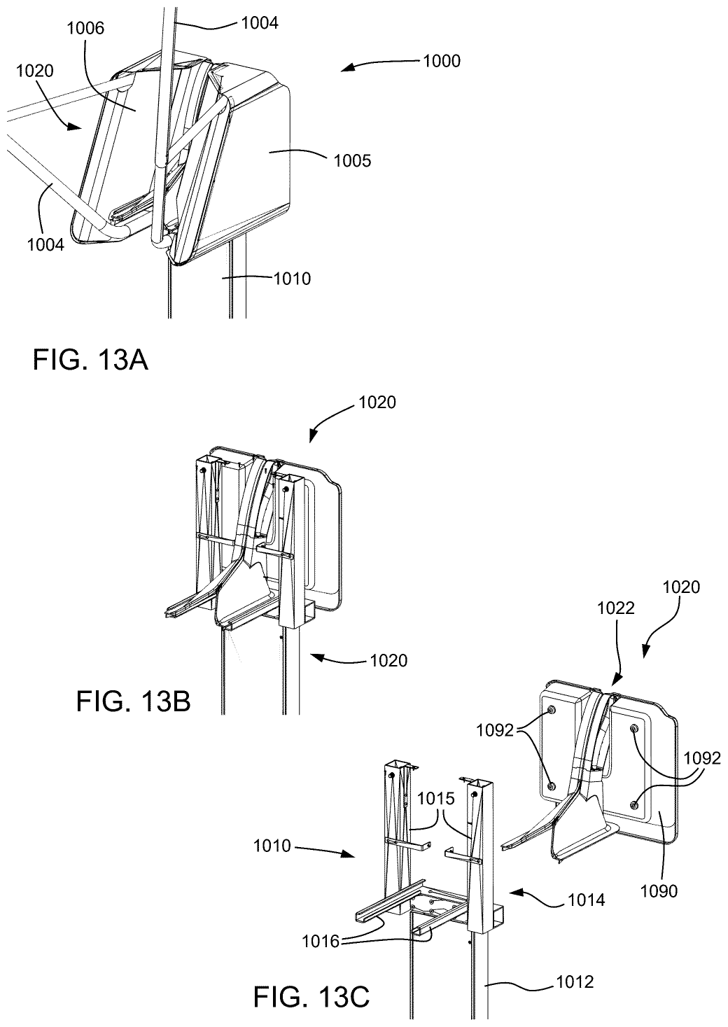

The illustrated payload retrieval apparatus 1000 shown in FIGS. 9 and 10 has a modular construction that may provide various advantages. For example, the retriever guide 1020 is configured as a modular assembly that is separate from the support structure 1010. Accordingly, as shown in FIGS. 13A-13C, the retriever guide 1020 can be removed from or secured to the support structure 1010 as a unit for maintenance, service, cleaning, wear, version upgrading, initial installation or other actions. FIG. 13A shows the payload retrieval apparatus 1000 fully assembled with the retriever guide 1020 secured in the support structure 1010. Most of the retriever guide 1020 is obscured in FIG. 13A by an outer shroud 1005, an inner shroud 1006 and the tether engagers 1004. The outer and inner shrouds 1005, 1006 protect the internal components of the payload retrieval apparatus 1000 from the environment and from tampering by individuals. In FIG. 13B, the outer shroud 1005, inner shroud 1006 and tether engagers 1004 are hidden so that the retriever guide 1020 and portions of the support structure 1010 are visible. The shrouds 1005, 1006 and tether engagers 1004 are also hidden in FIG. 13C and the retriever guide 1020 is removed from the support structure 1010.

The support structure 1010 includes a support frame 1014 at the upper end of pedestal 1012 that securely holds the retriever guide 1020 in place as a payload retriever is pulled through the channel 1022. The support frame 1014 includes a pair of vertical frame members 1015 that support the upper portion of the retriever guide 1020. The vertical frame members 1015 are secured to the retriever guide 1020 through attachment to the payload bay 1090. Specifically, the payload bay 1090 is secured to the vertical frame members 1015 with fasteners that extend through four holes 1092 in the payload bay 1090. The support frame 1014 also includes a pair of horizontal frame members 1016 that support the lower portion of the retriever guide 1020. The horizontal frame members 1016 hold opposing sides of the funnel 1040 through a sliding engagement as explained in more detail below.

To mount the retriever guide 1020 to the support frame 1014, the funnel 1040 is slid into engagement with the horizontal frame members 1016 until the payload bay 1090 engages the vertical frame members 1015. The vertical frame members 1015 may then be secured to the payload bay 1090 using fasteners. Removal of the retriever guide 1020 from the support frame 1014 may be carried out in the reverse order, by first detaching the retriever guide from the vertical frame members 1015 and then sliding the funnel 1040 out from engagement with the horizontal frame members 1016. In other embodiments, the vertical frame members may be configured to have a sliding engagement while the horizontal frame members are secured with fasteners. Further still, in some embodiments, the retriever guide may be secured to the support frame without any sliding engagement. Any combination of bolts, latches, screws, or other fasteners may be used to secure the retriever guide to the support frame.

In the illustrated embodiment, one of each of the vertical frame members 1015 and horizontal frame members 1016 is positioned on one side of the channel 1022 of the retriever guide 1020 while the others are positioned on the opposing side. Accordingly, the support frame can help to keep the opposing sides of body 1021 of the retriever guide 1020 in their desired position, for example to maintain the gap in the tether slot 1025.

The configuration of the retriever guide 1020 being a separate assembly from the support structure 1010 provides several advantages. For example, the retriever guide 1020 and support structure 1010 may be formed of different materials to accommodate different functions of those components. For instance, in some embodiments, components of the retriever guide 1020 may be formed of polymer materials, which may be inexpensively formed in various complex shapes, such as by molding, thermoforming, printing or extruding, to perform specific functions as described in more detail below, while components of the retriever guide are formed of stronger, stiffer, or thicker materials, such as metal beams and channels.

This construction also allows the retriever guide 1020 to be removed from the support structure 1010 for maintenance. For example, if a component of the retriever guide 1020 is not operating correctly, the retriever guide 1020 may be removed from the support structure 1010, and transported to a facility for maintenance. The retriever guide 1020 alone, in comparison to the entire payload retrieval apparatus 1000, may be significantly easier to transport to the maintenance facility. Moreover, a replacement retriever guide 1020 can be immediately inserted into the support structure 1010 to allow operation to commence while maintenance is performed on the original retriever guide. Alternatively, if the support structure 1010 is left empty during the maintenance, the visible exterior of the payload retrieval apparatus 1000 will remain in place, thereby avoiding the possibility of another object occupying the payload retrieval apparatus' site while the maintenance is carried out.

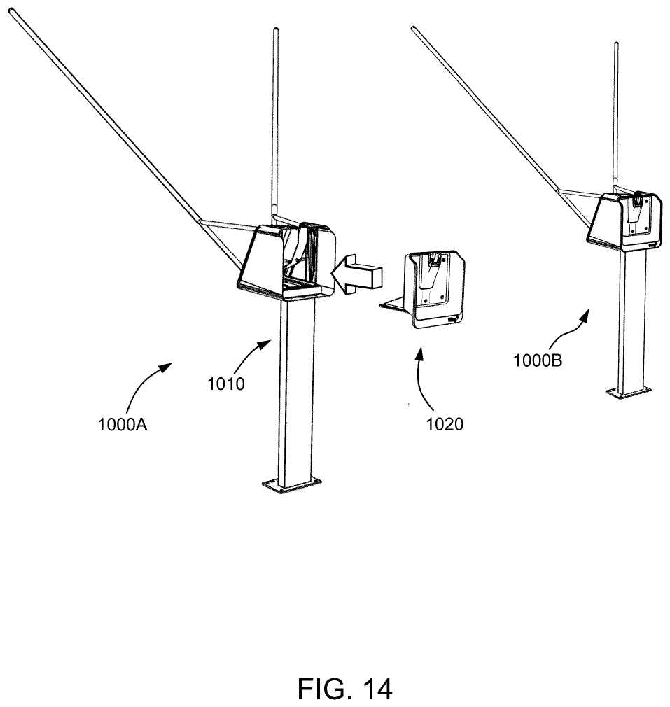

Further, by having the retriever guide 1020 formed as a separate assembly from the support structure 1010, the support structure 1010 may be installed as a permanent structure during construction of certain infrastructure, such as a parking lot. The retriever guide 1020 may be assembled off-site and then installed in the support structure 1010 closer in time to the deployment of the payload retrieval apparatus 1000. As an example FIG. 14 shows a pair of payload retrieval apparatuses 1000A and 1000B. The retriever guide 1020 of payload retrieval apparatus 1000A is currently removed from the support structure 1010. The arrow in FIG. 14 illustrates that the retriever guide 1020 is being inserted into the installed support structure 1010 of the payload retrieval apparatus 1000A.

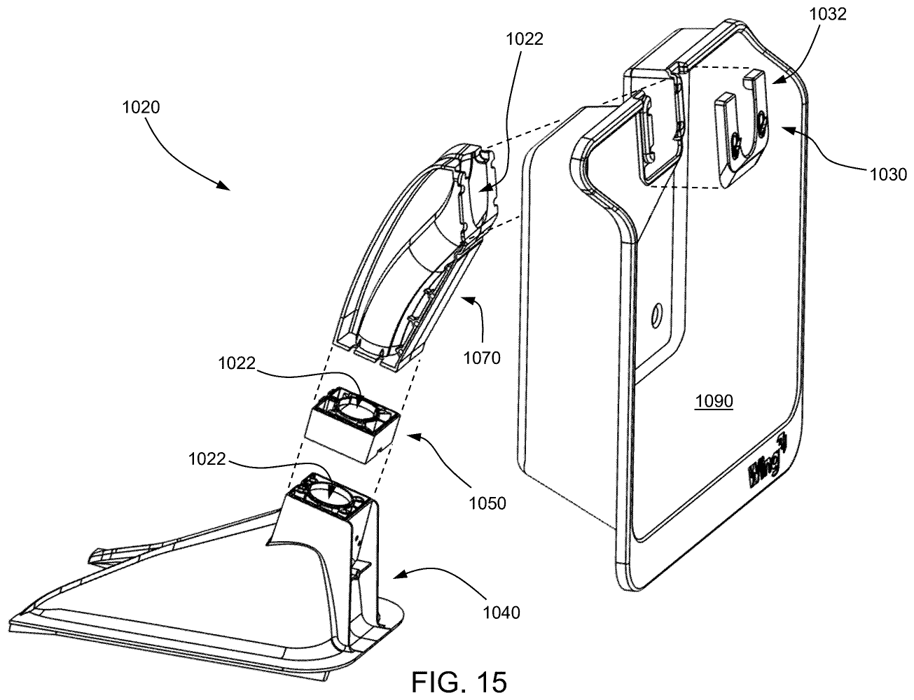

In some embodiments, the retriever guide 1020 itself has a modular structure. For example, as shown in FIG. 15, the illustrated retriever guide 1020 is assembled of multiple pieces. The pieces of the retriever guide 1020 form the separate components described above with respect to FIGS. 11A-11C and include the funnel 1040, the rotator 1050, the angle adjuster 1070, the payload bay 1090, and a holding frame 1032 that includes the payload holder 1030. In the illustrated embodiment, the rotator 1050 is coupled immediately downstream of the funnel 1040 such that the funnel 1040 and rotator 1050 are directly attached to one another. Likewise, the angle adjuster 1070 is immediately downstream of the rotator 1050 and the rotator 1050 and angle adjuster 1070 are directly attached to one another. The holding frame 1032 is secured to the exit end of the angle adjuster 1070 with the payload bay 1090 therebetween, as explained further below.

Each of the funnel 1040, rotator 1050 and angle adjuster 1070 provides a portion of the body 1021 of the retriever guide 1020 that forms the channel 1022. For instance, each of these components include the interior wall that surrounds the channel 1022. Likewise, each of the funnel 1040, rotator 1050, and angle adjuster 1070 includes the tether slot 1025 (e.g., FIG. 11B) that provides access to the channel 1022. As explained above, the tether slot is configured to accommodate a tether that pulls a payload retriever through the retriever guide 1020.

The modular construction of the retriever guide 1020 allows the different components to be manufactured according to their functionality. For example, one component may be cast while another is thermoformed in instances where these different manufacturing methods are better suited for the particular function being provided by the design of the component.

The modular construction of the retriever guide 1020 also may allow more efficient maintenance. For example, if the retriever guide 1020 of a payload retrieval apparatus 1000 becomes nonoperational, the retriever guide 1020 may be removed from the support structure 1010, as explained above. The retriever guide 1020 may then be disassembled so that one or more nonoperational components can be removed and replaced with new or refurbished components. The retriever guide 1020 can then be reintroduced into operation, while the nonoperational component is repaired.

While the illustrated retriever guide 1020 includes the rotator 1050 immediately downstream of the funnel 1040 and the angle adjuster 1070 immediately downstream of the rotator 1050, in other embodiments additional components may be included between the funnel, rotator, and angle adjuster. Further, although the illustrated embodiment described herein includes a modular retriever guide, in other embodiments components of the payload retrieval apparatus may be formed of fewer pieces, such as two opposing halves that are secured together in clamshell design, or in a single piece.

### VIII. Illustrative Retriever Guide Components

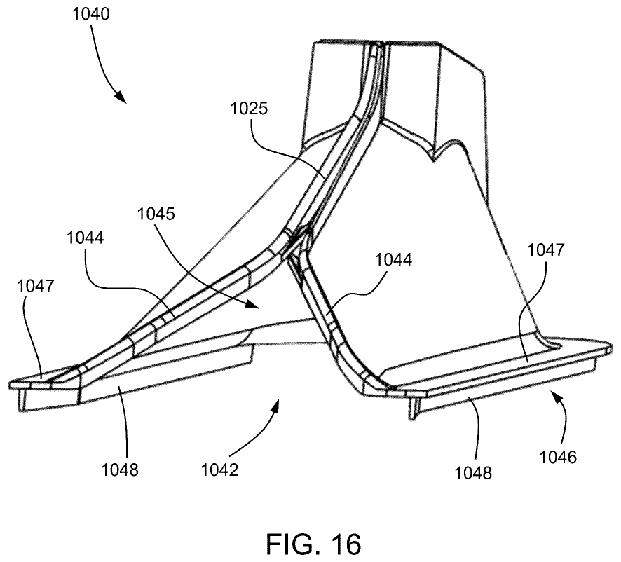

FIG. 16 is a perspective view of the funnel 1040 of the retriever guide of FIGS. 11A-11C. As explained above, the funnel 1040 includes a wide mouth 1042 toward the bottom where a payload retriever may enter the funnel 1040. The funnel 1040 narrows toward the inlet end of the channel 1022 to direct the payload retriever toward the payload holder at the exit end of the channel. As shown, the tether slot 1025 extends along the top of the funnel 1040 so that a tether can extend from above and pass through to a payload retriever being drawn up from beneath the funnel 1040. The funnel 1040 includes a V-shaped entrance 1045 that leads to the tether slot 1025 for guiding the tether into the tether slot. The V-shaped entrance 1045 is formed by angled edges 1044 on opposing sides of funnel 1040 that taper inward toward the tether slot 1025. The angled edges 1044 may be positioned to cooperate with the tether engagers so that the deployed tether can smoothly transition from a tether engager to an angled edge 1044 of the funnel and into the tether slot 1025. These angled edges 1044 also help the tether move quickly toward the tether slot 1025 and avoid the tether being temporarily arrested against an edge of the retrieval apparatus.

The funnel 1040 also includes a base 1046 that cooperates with the support frame (FIGS. 13A-13C) so that the funnel 1040 is securely held in place. On each side of the funnel 1040, the base 1046 includes a lateral lip 1047 that extends horizontally outward and a vertical flange 1048 that extends downward. The support frame of the support structure includes a respective channel within each horizontal frame member that is configured to receive the lateral lip 1047 and vertical flange 1048 on a corresponding side of the funnel 1040. To secure the funnel on the support structure, opposing sides of the base 1046 are inserted into the channel and the funnel is slid into place. The ends of each vertical flange 1048 flare outward to ease insertion of the base into the corresponding channels of the support frame.

Once the funnel 1040 is coupled to the support frame, the internal surface of each vertical flange 1048 abuts a respective frame member so that the opposing sides of the funnel 1040 are pushed outward. Accordingly, the funnel 1040 may be slightly biased inward but held open by the support frame in order to keep the tether slot 1025 open. In some embodiments, the lateral stiffness of the support frame is greater than the lateral stiffness of the funnel. The term lateral stiffness, as used herein, refers to the stiffness in the direction that is perpendicular to the path of the channel, such as the direction from one vertical 1048 to the other in the illustrated embodiment. For example, the support frame may be made of a stronger or stiffer material (e.g., a steel or aluminum support frame and a plastic funnel), or a thicker material. Accordingly, the shape of the funnel 1040 may be partially maintained by the support structure, which may ease other manufacturing requirements for the funnel.

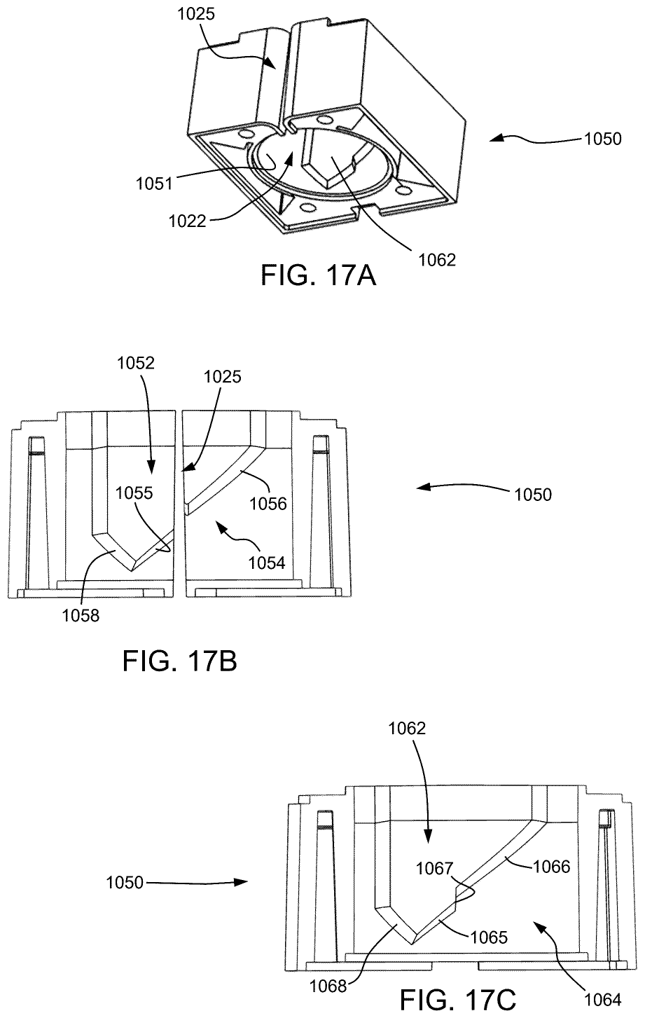

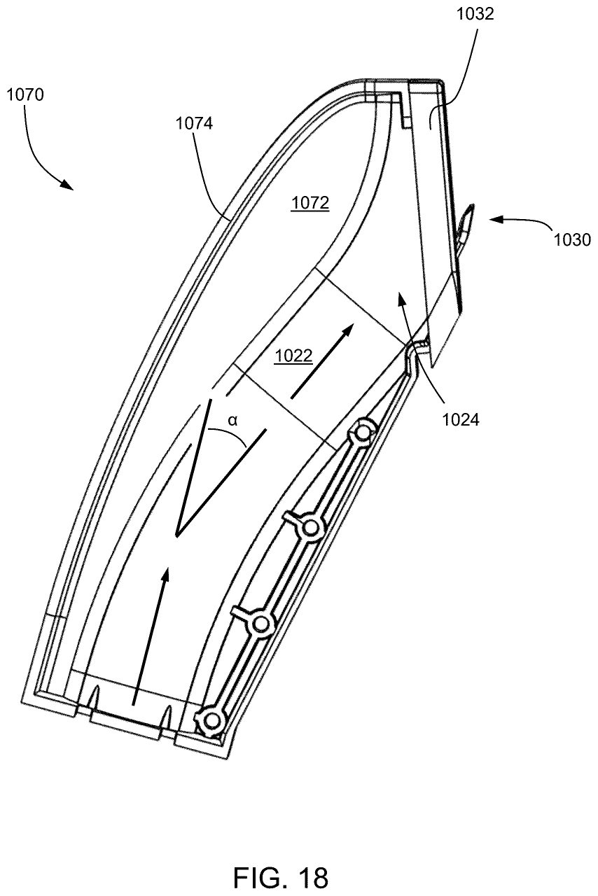

FIGS. 17A-17C show the rotator 1050 in isolation. The rotator 1050 is provided downstream of the funnel 1040 and forms part of the channel 1022 that guides a payload retriever to a retrievable payload. FIG. 17A is a lower perspective view of the rotator 1050 and shows a portion of the tether slot 1025, which allows a tether to pass through the rotator 1050 in connection with the payload retriever passing through the channel. The channel 1022 is surrounded by an interior surface 1051 of the rotator 1050. As shown in FIGS. 17B and 17C, two camming structures 1052, 1062 are provided on the interior surface 1051 of the rotator 1050. FIG. 17B is a cross-sectional view that shows the portion of the rotator 1050 that includes the tether slot 1025, while FIG. 17C is a cross-section that shows the portion of the rotator 1050 that is opposite the tether slot. As shown in FIG. 17B, the first camming structure 1052 is positioned on the side of the rotator 1050 that includes the tether slot 1025. In contrast, the second camming structure 1062 is opposite the first camming structure and shown in FIG. 17C. Each of the camming structures extends around the interior surface 1051, as illustrated by the second camming structure 1062 in FIG. 17A.

The camming structures 1052, 1062 are configured to rotate a payload retriever as it is pulled through the channel. To impart the rotation to the payload retriever, the first camming structure includes a first angled surface 1054 that extends about the interior of the rotator 1050 in a first direction and a second angled surface 1058 that extends about the interior of the rotator 1050 in the opposite direction. Both angled surfaces 1054, 1058 are adapted to engage a protrusion on the payload retriever and cause the payload retriever to rotate as the protrusion slides along the respective angled surface 1054, 1058. If the protrusion engages the first angled surface 1054 it will rotate in the first direction, and if the protrusion engages the second angled surface 1058 it will rotate in the second direction.

As shown in FIG. 17B, the tether engager 1025 extends through the first camming structure 1052 and intersects the first angled surface 1054. As a result, the first angled surface 1054 includes a first portion 1055 disposed on one side of the tether slot 1025 and a second portion 1056 disposed on another side of the tether slot 1025. Both the first portion 1055 and the second portion 1056 extend around the channel in the first direction and cause the payload retriever to rotate in the first direction. To avoid the protrusion of the payload retriever from being caught in the tether slot 1025 as it slides along the first angled surface 1054, the second portion 1056 of the first angled surface 1054 is offset slightly downstream (i.e., up) from the first portion 1055. Accordingly, when the protrusion of the payload retriever reaches the tether slot 1025, it will jump from the first portion 1055 of the first angled surface 1054 to the second portion 1056 rather than getting stuck against an edge of the tether slot.

As shown in FIG. 17C, the second camming structure 1062 has a similar configuration as the first camming structure 1052, but disposed on the opposite side of the rotator 1050. The second camming structure includes a third angled surface 1064 that extends about the rotator in the first direction and a fourth angled surface 1068 that extends about the rotator in the second direction. The third and fourth angled surfaces 1064, 1068 are configured to engage another protrusion on the payload retriever and also rotate the payload retriever. The use of two camming structures 1052, 1062 may help balance the forces on the payload retriever as it is rotated within the rotator 1050. In the illustrated embodiment, the third angled surface 1064 includes a first portion 1065 and a second portion 1066 that correspond to the portions of the first angled surface 1054. Moreover the third angled surface 1064 includes a step 1067 that corresponds to the offset of the first angled surface 1054.

Each section of the angled surface follows a helical path around the interior of the channel 1022. The respective portions of the first and third angled surfaces follow helical paths that extend about the rotator in the first direction and are offset from one another. The second and fourth angled surfaces, in contrast, each follow a respective continuous helical path.

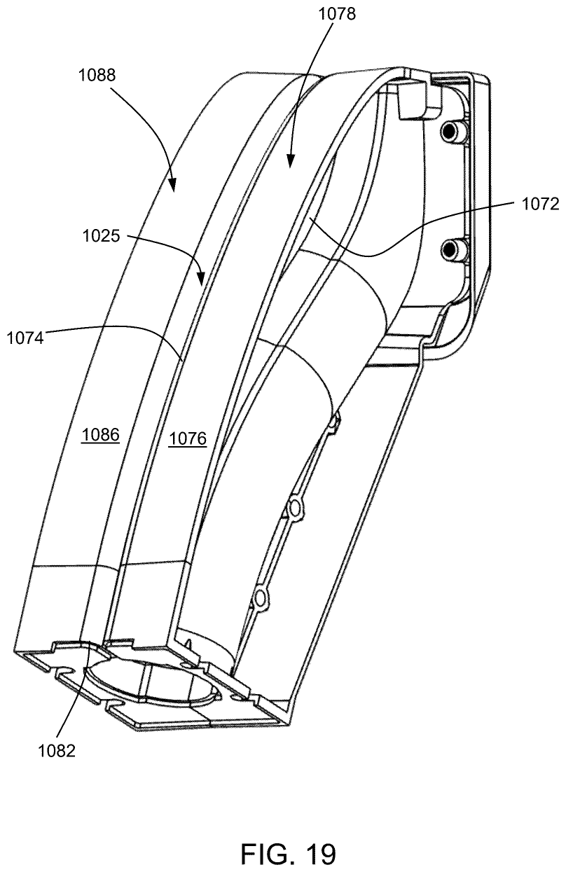

From the rotator 1050, the channel continues in the angle adjuster 1070, which is shown in FIGS. 18 and 19 with a holding frame 1032 for the payload holder 1030. As shown in FIG. 18, at an inlet end of the angle adjuster 1070 the channel 1022 has a relatively steep inclination. The angle adjuster 1070 reduces the angle of inclination of the channel 1022 to aid in retrieving a payload from the payload holder as explained above. The change in the angle of inclination is gradual relative to the size of the channel in order to avoid the payload retriever from being caught within the channel, as might happen with a sharper turn within the retriever guide. For example, the radius of curvature of the change in the angle of the channel is substantially greater than the width of the channel, such as at least three times the width of the channel. The change in the angle of inclination is illustrated in FIG. 18 by angle α.

In some embodiments, the angle adjuster 1070 reduces the angle of inclination by at least 15 degrees, for example about 25 degrees. As a result, a payload retriever being drawn through the retriever guide 1020 has a substantial forward component as it reaches the end of the channel and engages the payload. For example, near the exit end 1024, the channel 1022 may have an angle of inclination in a range of 45 to 65 degrees, or about 50 degrees.

Similar to the funnel 1040 and the rotator 1050, the angle adjuster 1070 includes a portion of the tether slot 1025 that is adapted to provide a tether with access to a payload retriever being drawn through the channel 1022. If the UAV that is coupled to the tether is not directly aligned along the direction of the tether slot 1025, the tether will come out of the tether slot at an angle and bend around the edge of the tether slot. This bend around the edge of the tether slot may result in high friction on the tether, thereby reducing the force available for pulling the payload retriever through the channel. To limit the friction on the tether and reduce the likelihood that the tether wraps around the edge of the tether slot, the illustrated angle adjuster 1070 includes a first retaining wall 1072 on one side of the tether slot and a second retaining wall 1082 on the opposite side of the tether slot (FIG. 19). The two retaining walls 1072, 1082 provide a guide for the tether and hold the tether in a substantially vertical orientation at the opening in the channel 1022. The two retaining walls 1072, 1082 extend upward from the body 1021 of the retriever guide that forms the channel 1022. Further, the retaining walls 1072, 1082 run parallel to one another with a small gap therebetween to accommodate the tether.

The retaining walls 1072, 1082 are configured to encourage a tether that is extending outward from the tether slot 1025 at an angle to continue moving upward along the tether slot 1025. For example, as shown in FIG. 18, the angle of inclination of the outer edge 1074 of the retaining wall 1072 continuously decreases from the inlet of the angle adjuster 1070 to the exit end 1024 of the channel 1022. In contrast, the portion of the angle adjuster 1070 that is above the opening and payload holders 1030 curves upward. Without the retaining walls 1072, 1082, a tether may be inclined to wrap around the edge of the tether slot in this area and cause the tether to get caught. On the other hand, with the inclusion of the retaining walls 1072, 1082, the tether is encouraged to move further upward along the gradually falling outer edge 1074 of the retaining wall 1072.

As shown in FIG. 19, the first retaining wall 1072 includes a reinforcing flange 1076 that extends laterally outward and away from the tether slot 1025 at the outer edge 1074 of the first retaining wall. The second retaining wall includes a similar reinforcing flange 1086 that extends outward from the tether slot 1025 in the opposite direction.

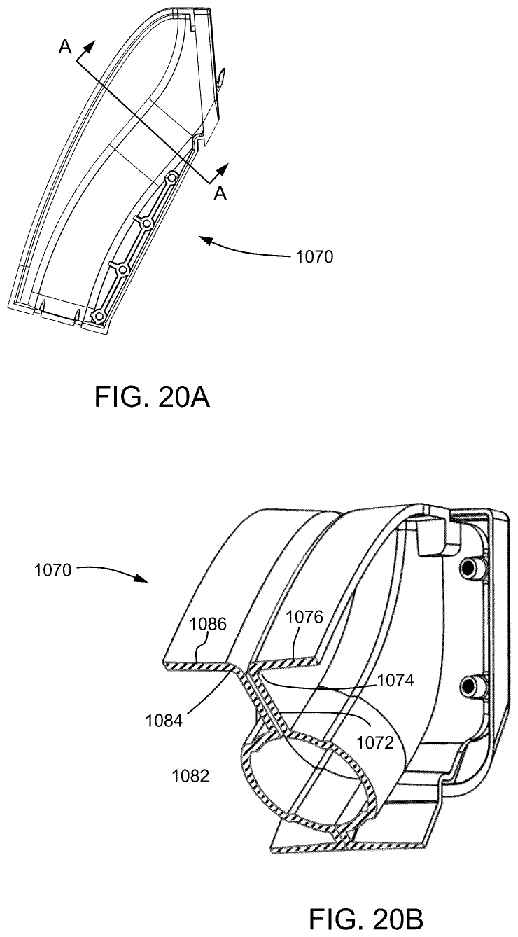

The shape of the first and second retaining walls 1072, 1082 and the corresponding reinforcing flanges 1076, 1086 is shown more clearly by a cross section taken along the length of the angle adjuster 1070. Such a cross section is shown in FIG. 20B and is taken along line A-A shown in the side view of FIG. 20A. In this view, the parallel configuration of the first retaining wall 1072 and the second retaining wall 1082 is more clearly visible. Likewise, the outward extension of the reinforcing flanges 1076, 1086 away from the tether slot can be seen more clearly in FIG. 20B.

The reinforcing flanges 1076, 1086 increase the stiffness of the angle adjuster 1070 so that the angle adjuster 1070 may retain its shape under forces caused by the tether or the environment. Further, the transition between each retaining wall 1072, 1082 and reinforcing flange 1076, 1086 at the respective outer edge 1074, 1084 may be curved in order to limit localized forces on the tether. In some embodiments, the radius of curvature of the transition is greater than the thickness of the retaining wall.

In the illustrated embodiment, the angle adjuster 1070 is formed by respective first and second parts 1078, 1088, as shown in FIG. 19, that make up the opposing lateral sides of the angle adjuster on either side of the tether slot. Thus, the first part 1078 forms the first retaining wall 1072 and reinforcing flange 1076, while the second part 1088 forms the second retaining wall 1082 and reinforcing flange 1086. The two parts 1078, 1088, along with their respective retaining walls 1072, 1082 and reinforcing flanges 1076, 1086 are symmetrical. The opposing parts 1078, 1088 are connected by fasteners and also held together by their respective connection to the rotator and the holding frame 1032. In other embodiments, however, the angle adjuster may be formed by a single part.

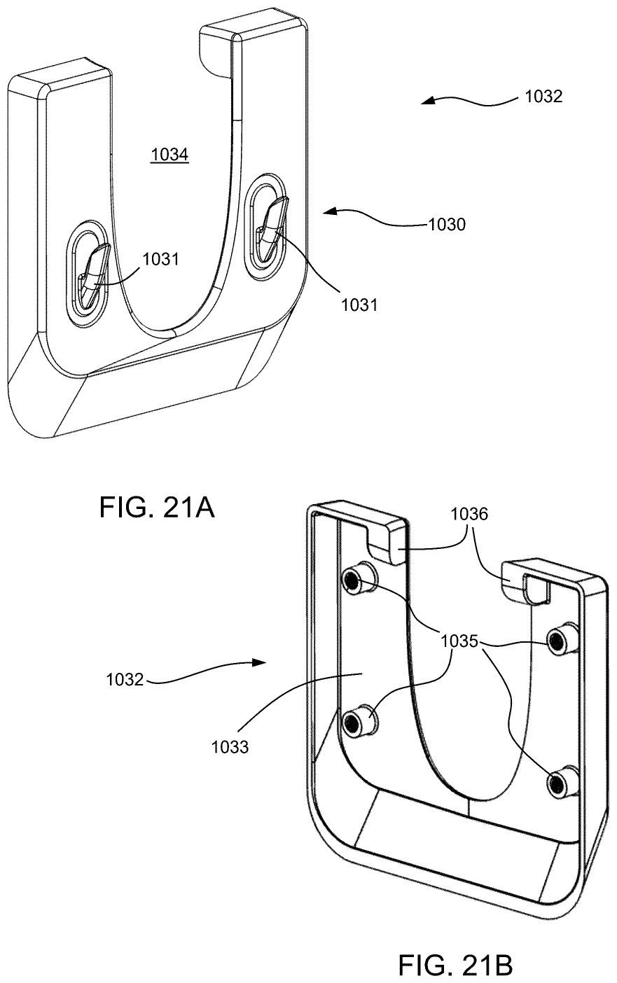

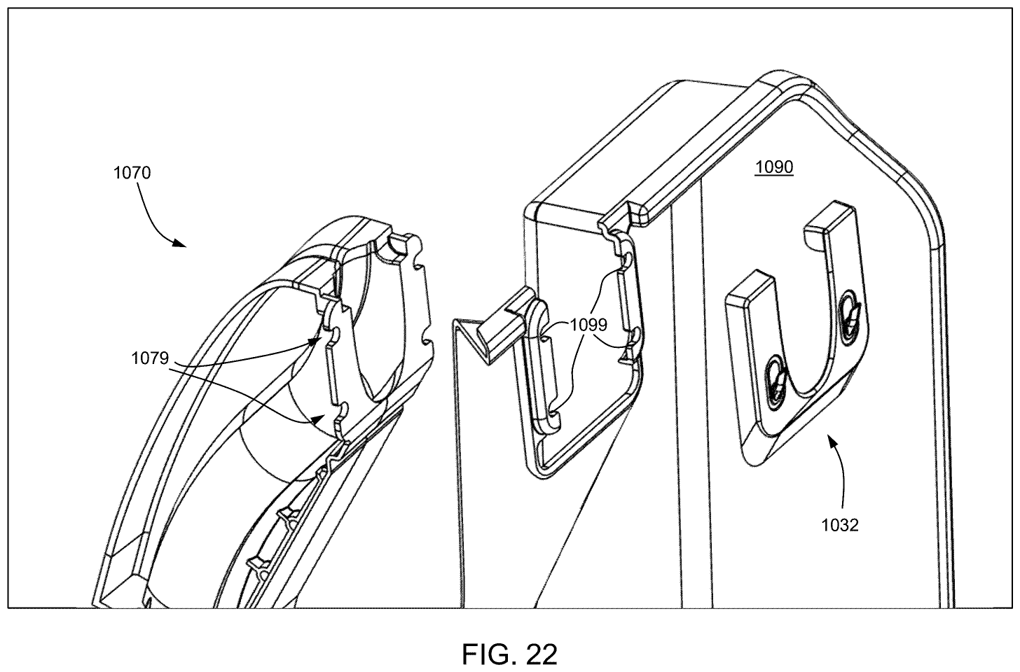

FIG. 21A is a perspective front view of a holding frame 1032 in the form of a faceplate that includes the payload holder 1030 at the exit end of the channel of the payload retrieval apparatus shown in FIGS. 9-14. The faceplate 1032 includes a body 1033 extending around a passage 1034 that is configured to align with the exit end of the channel of the retriever guide. As explained above, the payload holder 1030 is configured to hold a payload at the exit end of the channel for retrieval by a payload retriever as it moves through the passage 1034. In the illustrated embodiment, the body 1033 of the faceplate 1032 has a U-shaped configuration such that the top of the passage 1034 is open. This allows the payload retriever to be pulled upward as it exits the channel and lift the payload from the payload holder 1030.

The payload holder 1030 is formed by a pair of hooks 1031 that extend outward from a surface of the body 1033 of the faceplate 1032. One of the hooks 1031 is disposed on one side of the passage 1034 and the other hook 1031 is disposed on the opposite side of the passage 1034 so that the two hooks can evenly hold two sides of the payload for receipt by the retriever. In some embodiments, the body 1033 of the faceplate 1032 includes indicia to visually highlight the location of the hooks 1031. For example, as shown in FIG. 21, each of the hooks 1031 is surrounded by a groove that draws attention to the hook 1031. The grooves may be brightly colored or otherwise visually emphasized to notify a user of the location to place a payload for retrieval.

The body 1033 of the faceplate 1032 is adapted for securely connecting the faceplate 1032 to the retriever guide. FIG. 21B shows a rear side of the faceplate 1032. As shown, the body 1033 of the faceplate 1032 includes a plurality of receptacles, such as bosses 1035, that are configured to receive fasteners for securing the faceplate 1032 to the retriever guide. FIG. 22 shows an exploded view of the faceplate 1032, and portions of the angle adjuster 1070 and payload bay 1090 of the retriever guide. The body 1033 of the faceplate 1032 is configured to fit over a portion of payload bay 1090 and the end of the angle adjuster 1070, with the portion of the payload bay 1090 held between the angle adjuster 1070 and faceplate 1032. To secure the components together, the angle adjuster 1070 includes a series of apertures 1079 configured to receive fasteners that are held in the bosses 1035. Likewise, the payload bay 1090 includes similar apertures 1099 for the fasteners. With the faceplate 1032 placed over the payload bay 1090 and angle adjuster 1070, the fasteners, such as bolts, may be inserted and tightened to hold the components together.

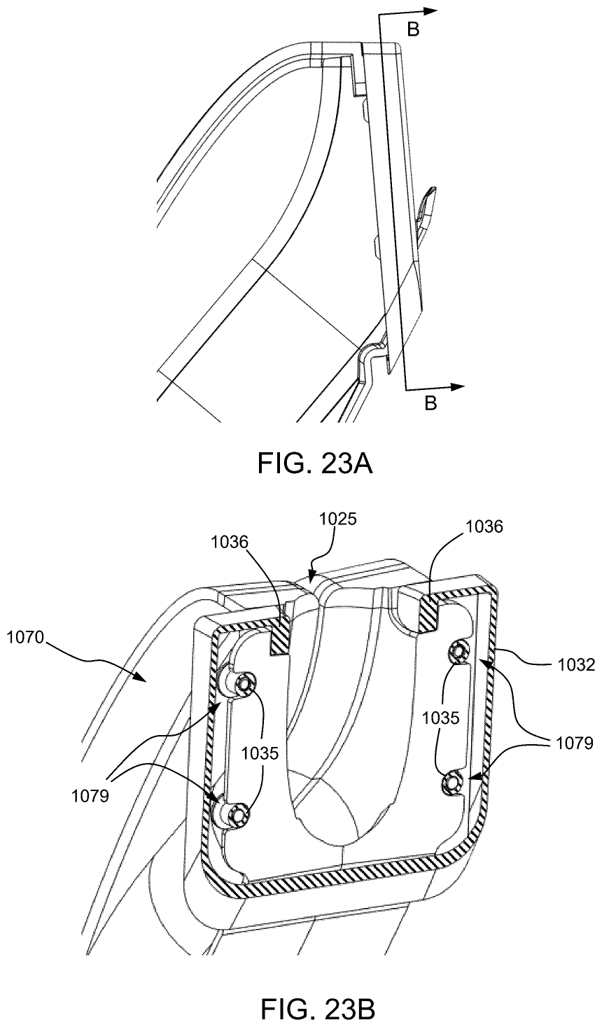

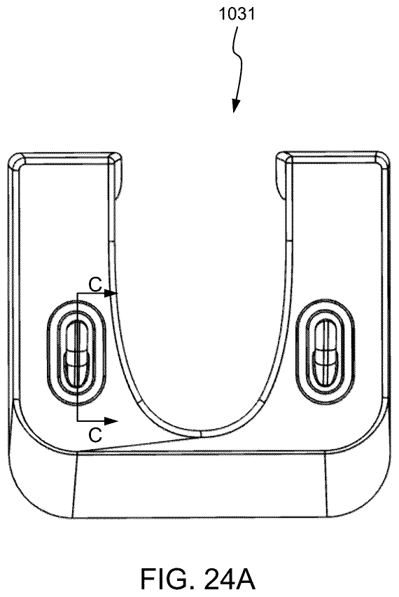

The body 1033 of the faceplate 1033 may also include abutments 1036, as shown in FIG. 21B, that hold the opposing portions of the angle adjuster 1070 apart, in order to maintain a gap within the tether slot. The cross-section of FIG. 23B, which is taken along line B-B of FIG. 23A, illustrates the connection between the faceplate 1032 and the angle adjuster 1070. As shown, the bosses 1035 of the faceplate 1032 extend through the apertures 1079 in the angle adjuster 1070, thereby bounding the angle adjuster 1070 on either side. The faceplate 1032 also wraps around the top of the angle adjuster 1070, such that the abutments 1036 are positioned between opposing sides of the angle adjuster. Accordingly, the abutments 1036 provide an outward facing support for the angle adjuster 1070 and can help maintain the distance between opposing sides of the angle adjuster 1070 within the tether slot 1025, so as to maintain the appropriate gap of the tether slot 1025.

In some embodiments, the lateral stiffness of the faceplate is greater than the lateral stiffness of the angle adjuster. The term lateral stiffness, as used herein, refers to the stiffness in the direction that is perpendicular to the path of the channel, such as the direction from one abutment 1036 to the other in the illustrated embodiment. The greater lateral stiffness of the faceplate 1032 compared to the angle adjuster 1070 allows the faceplate 1032 to help maintain the shape of the angle adjuster 1070. The greater lateral stiffness may be imparted by a difference in materials of the faceplate 1032 and angle adjuster 1070. For instance, the faceplate 1032 may be made of a stronger material (e.g., a steel or aluminum faceplate compared to a plastic angle adjuster) or a thicker material.

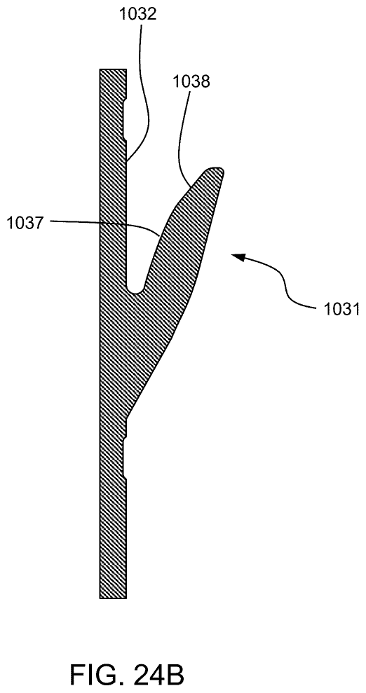

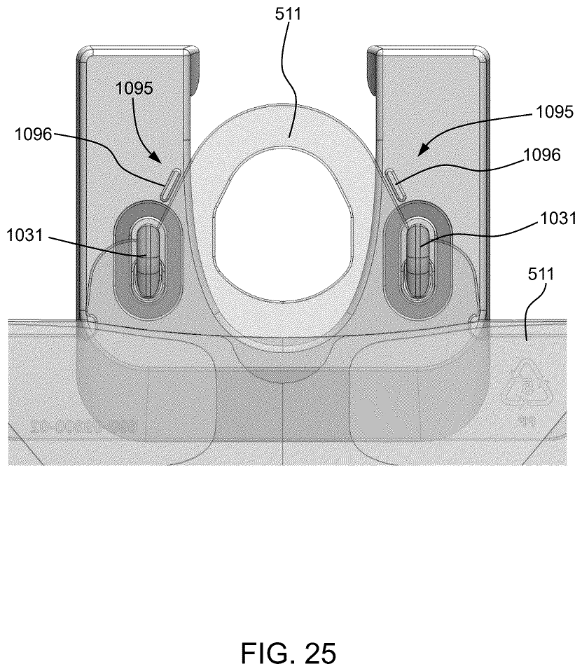

FIG. 24 illustrates a detailed cross-sectional side view of one of the hooks 1031. Each hook 1031 of the illustrated embodiment includes a steep inner surface 1037 on the inside of the hook 1031 that extends at an acute angle to the surface of the faceplate 1032. In various embodiments, the steep inner surface 1037 may be inclined with respect to the surface of the faceplate 1032 in a range of 10 to 25 degrees, such as about 15 degrees. The steep inner surface 1037 may assist a hanging portion of the payload, such as a handle, to drop to the closed end of the hook opening.

To provide sufficient room for the received portion of the payload, such as the handle, the gap at the closed end of the hook opening may be sized slightly larger than the thickness of the payload handle, such as up to twice the thickness. On the other hand, in some embodiments, if the payload handle is compressible, the closed end of the hook opening may be narrower than the thickness of the payload handle.

Loading of the payload handle onto the hooks 1031 may be assisted by an angled entry surface 1038 on the inside of the hook 1031. The angle of the entry surface 1038 may be shallower than the steep inner surface 1037 and disposed at an angle in a range of 25 to 50 degrees, such as about 40 degrees, with respect to the surface of the faceplate. By extending away from the front surface of the faceplate at a shallower angle, the hook can extend to a pointed tip with a sizable opening for receiving the handle of the payload. To further assist loading, the tops of the hooks 1031 may be rounded across the lateral direction, as shown in FIG. 21A. This allows the hooks to easily enter an aperture in the payload handle.

In addition to easing loading of a payload onto the payload holder, the configuration of the hooks 1031, including the angled inner surfaces 1037, 1038, also increase the reliability of removing a payload that is held on the hooks 1031. In particular, such a configuration can help increase the likelihood of removing the payload at a variety of different angles along which the tether extends up to the UAV. This allows the UAV to retrieve the payload from the hooks without the need to hover in a very precise location.

In some embodiments, the faceplate includes an alignment structure that is configured to properly position a hanger of a payload on the hooks. For example, faceplate 1032 of the illustrated embodiment includes an alignment structure 1095 that is formed by a pair of protrusions 1096 on either side of the passage 1034 in the middle of the faceplate 1032. The protrusions 1096 are positioned to border a handle 511 of a payload 510 when the handle 511 is properly seated on the hooks 1031 of the payload holder 1030, and form an obstruction if the handle 511 would otherwise start to move out of place. As a result, once a user fully places the payload handle 511 on the hooks 1031, with the protrusions 1096 adjacent to the outer edge of the handle 511, the protrusions 1096 can help hold the payload handle 511 in place on the hooks 1031. Accordingly, even if the payload 510 is asymmetrically loaded, such that it might have a tendency to rotate about one of the hooks 1031 and possibly lift off the other, the protrusions 1096 can hold the payload handle 511 in place on the faceplate 1032.

In some embodiments, in order to place the payload handle 511 in the designated location defined by the protrusions 1096, a slight deformation of the handle 511 may occur as the handle 511 is pushed into place. Once the handle 511 is in place, the deformation is no longer needed and the handle 511 may snap back to its original shape. This insertion of the handle 511 on the hooks 1031 may provide tangible feedback and an audible click when the handle 511 is properly seated at the bottom of the hook openings. Further, the deformation needed to insert the payload handle 511 into place also acts as an obstruction to the handle 511 inadvertently moving out of place once loaded on the hooks 1031.

To bypass the protrusions 1096 when the UAV is retrieving the payload, the handle 511 of the payload 510 may be bent outward as shown in FIG. 12. This bending of the handle 511 moves the handle 511 past the protrusions 1096 so that it can be pulled upward by a payload retriever.

### IX. CONCLUSION

The particular arrangements shown in the Figures should not be viewed as limiting. It should be understood that other implementations may include more or less of each element shown in a given Figure. Further, some of the illustrated elements may be combined or omitted. Yet further, an exemplary implementation may include elements that are not illustrated in the Figures.

Additionally, while various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A payload retrieval system comprising:
a support structure;
a retriever guide coupled to the support structure, the retriever guide forming a channel having an inlet end and an exit end, wherein the retriever guide is adapted to receive a payload retriever at the inlet end of the channel and direct the payload retriever to the exit end of the channel;
a faceplate coupled to the retriever guide, the faceplate comprising:
a body extending around a passage aligned with the exit end of the channel, and
a payload holder including first and second hooks adapted to hold a payload for receipt by a payload retriever that passes through the retriever guide.

2. The payload retrieval system of claim 1, wherein a lateral stiffness of the faceplate is greater than a lateral stiffness of a portion of the retriever guide at the exit end of the channel.

3. The payload retrieval system of claim 1, wherein the body of the faceplate has a U-shaped configuration such that a top of the passage is open.

4. The payload retrieval system of claim 1, wherein the first hook is disposed on one side of the passage and the second hook is disposed on a second side of the passage.

5. The payload retrieval system of claim 1, wherein each of the first and second hooks includes an angled inner surface facing the body of the faceplate, and wherein the angled inner surface of the hook is disposed at an acute angle to a front surface of the body of the faceplate.

6. The payload retrieval system of claim 1, wherein the body of the faceplate includes indicia that visually highlights the location of the first and second hooks.

7. The payload retrieval system of claim 1, wherein the first and second hooks extend outward from a front surface of the body of the faceplate, and wherein the faceplate includes an alignment structure extending outward from the front surface of the body of the faceplate that is configured to position a hanger of the payload.

8. The payload retrieval system of claim 7, wherein the alignment structure includes a first protrusion disposed on a first side of the passage and a second protrusion disposed on a second side of the passage.

9. The payload retrieval system of claim 1, further comprising a payload bay including first and second sidewalls that provide a protected cavity under the exit end of the channel.

10. The payload retrieval system of claim 9, wherein a portion of the payload bay is held between the faceplate and retriever guide.

11. The payload retrieval system of claim 10, wherein the support structure includes a support frame, wherein the retriever guide is attached to the support frame, and wherein the payload bay is attached to the support frame.

12. A payload retrieval system comprising:
a support structure;
a retriever guide formed of a first material and coupled to the support structure, wherein the retriever guide includes a channel having an inlet end and an exit end, the retriever guide being adapted to receive a payload retriever at the inlet end of the channel and direct the payload retriever to the exit end of the channel;
a faceplate formed of a second material that is different from the first material, the faceplate being coupled to the retriever guide and comprising:
a body extending around a passage aligned with the exit end of the channel, and
a payload holder adapted to hold a payload for receipt by a payload retriever that passes through the retriever guide.

13. The payload retrieval system of claim 12, wherein a lateral stiffness of the faceplate is greater than a lateral stiffness of a portion of the retriever guide at the exit end of the channel.

14. The payload retrieval system of claim 12, wherein the support structure is formed of a third material that is different from the first material.

15. The payload retrieval system of claim 14, wherein the second material and the third material are the same.

16. The payload retrieval system of claim 12, wherein the body of the faceplate has a U-shaped configuration such that a top of the passage is open.

17. The payload retrieval system of claim 12, wherein payload holder includes first and second hooks disposed on opposing sides of the passage.

18. The payload retrieval system of claim 17, wherein each of the first and second hooks includes an angled inner surface facing the body of the faceplate, and wherein the angled inner surface of the hook is disposed at an acute angle to a front surface of the body of the faceplate.

19. The payload retrieval system of claim 12, wherein the first and second hooks extend outward from a front surface of the body of the faceplate, and wherein the faceplate includes an alignment structure extending outward from the front surface of the body of the faceplate that is configured to position a hanger of the payload.

20. The payload retrieval system of claim 19, wherein the alignment structure includes a first protrusion disposed on a first side of the passage and a second protrusion disposed on a second side of the passage.
